(19) United States
(12) Patent Application Publication
(10) Pub. No.: US 2018/0240084 A1
(43) Pub. Date: Aug. 23, 2018

(54) SYSTEMS AND METHODS FOR PROVIDING AN ORCHESTRATION LAYER FOR SERVICE OFFERED BY EARLY WARNING SERVICES

(71) Applicant: Capital One Services, LLC, McLean, VA (US)

(72) Inventors: Derick Elmer Kealii KAKAIO, Draper, UT (US); Sivanandam Goundar CHINNACHI, Chantilly, VA (US); Prabhat SHARMA, Richmond, VA (US); Bob U. KOSHY, Henrico, VA (US); Eric Randolph MULL, Chesterfield, VA (US)

(73) Assignee: Capital One Services, LLC, McLean, VA (US)

(21) Appl. No.: 15/808,500

(22) Filed: Nov. 9, 2017

Related U.S. Application Data
(63) Continuation of application No. 15/805,962, filed on Nov. 7, 2017.
(60) Provisional application No. 62/461,767, filed on Feb. 21, 2017.

(51) Int. Cl. G06Q 20/04; G06Q 20/10

(52) U.S. Cl. CPC G06Q 20/042; H04L 67/10; G06Q 20/108

(57) ABSTRACT

Disclosed embodiments provide systems and techniques for a computerized orchestration layer that allows financial institutions to make real-time inquiries to other financial institutions when presented with a financial instrument. In some embodiments, disclosed systems and techniques may provide for processing a real-time payment at a depository bank. In some other embodiments, disclosed systems and techniques may provide for processing a real-time payment at a paying bank.

### CROSS-REFERENCE TO RELATED APPLICATIONS

This application claims priority under 35 U.S.C. § 119 to U.S. Provisional Application No. 62/461,767, filed on Feb. 21, 2017, which is expressly incorporated herein by reference in its entirety.

### BACKGROUND

Due to the increasing use of mobile devices and automated teller machines, electronically depositing financial instruments, such as checks, automated clearing house (ACH) transactions, notes, etc., is subject to increased delays and cyber security risks for financial institutions and their customers. When depositing a financial instrument, depository financial institutions must electronically obtain a payment guarantee over a network from paying institutions before guaranteeing the availability of funds to their customers. Currently, financial computer systems accomplish this through an overnight computer-implemented batch process.

During the overnight batch process, a depository financial institution sends electronic data representing a batch of physical financial instruments presented for deposit and scanned into a computer system of the depository financial institution, to obtain an electronic payment guarantee decision over a computer network for each financial instrument from the computer system of a paying financial institution. To minimize risks, depository and paying financial institutions must also run fraud and risk assessment software on each electronically deposited financial instrument before proceeding to allow the customer to withdraw deposited funds via their mobile device, an ATM, or the financial institution. The fraud and risk assessment software is needed because depositing financial instruments electronically adds new layers of security concerns, such as electronic fraud, phishing, networking security concerns, cyber security concerns, information security concerns, or the like. However, this fraud and risk assessment software may also delay electronic processing of the batch.

Because it delays the depository bank's ability to make the deposited fund available to the customer, this current electronic batch process leads to customer frustration. As noted above, this process takes a day or more to complete. Thus, customers who have deposited funds in their accounts cannot use their funds until at least the next day. In addition, customers of the paying institutions are also impacted because the timing of the withdrawal of funds from their accounts is not consistent. These customers may be charged overdraft fees due to not having enough funds in their account at the time that the funds are finally withdrawn.

In view of these and other shortcomings and problems with traditional systems, improved systems and techniques are needed for processing financial instruments in real time by receiving, processing, and providing immediate guarantee responses to allow financial institutions to make deposited funds available to customers in real time and give customers better control in funding a drawn financial instrument.

### SUMMARY

Disclosed embodiments provide systems and techniques for a computerized orchestration layer that enables real-time inquiries regarding a financial instrument. In some embodiments, disclosed systems and techniques enable the capability of electronically receiving and processing of an immediate payment guarantee response when a financial instrument, drawn on a paying financial institution (i.e., paying bank), is presented for deposit into the depository financial institution (i.e., depository bank). Further disclosed systems and techniques may enable the capability of electronically providing an immediate payment guarantee response for a financial instrument drawn on the paying bank when a request to guarantee that financial instrument is received from another financial institution. Accordingly, the disclosed embodiments provide enhancements for the system technology that governs the depositing of financial instruments (e.g., checks, personal checks, business checks, certified checks, bearer checks, cashier's checks, traveler's checks, automated clearing house (ACH) transactions, notes, etc.) into financial institutions. Furthermore, the disclosed embodiments address problems with the traditional system technology that governs the depositing of financial instruments into financial institutions by enabling such systems to process financial instruments in real time.

Consistent with the disclosed embodiments, a system is provided for electronically guaranteeing a real-time payment at a paying bank. The system may include a memory storing instructions and one or more processors. The one or more processors may be configured to execute instructions to serially receive, from one or more financial institutions via a communication network, a plurality of real-time requests comprising financial instruments that are being presented for deposit at the one or more financial institutions. The one or more processors may also be configured to execute instructions to serially determine a payment guarantee decision for each financial instrument, the payment guarantee decision specifying whether the payment for the financial instrument is or is not guaranteed. The one or more processors may further be configured to execute instructions to serially build a response for each payment guarantee decision. Moreover, the one or more processors may be configured to execute instructions to serially send the response for each payment guarantee decision to the one or more financial institutions via the communication network.

In addition, consistent with the disclosed embodiments, a method is provided for electronically guaranteeing a real-time payment at a paying bank. The method may include one or more steps of: serially receiving, from one or more financial institutions via a communication network, a plurality of real-time requests comprising financial instruments that are being presented for deposit at the one or more financial institutions; serially determining a payment guarantee decision for each financial instrument, the payment guarantee decision specifying whether the payment for the financial instrument is or is not guaranteed; serially building a response for each payment guarantee decision; and serially sending the response for each payment guarantee decision to the one or more financial institutions via the communication network.

Consistent with the disclosed embodiments, a system is also provided for electronically processing a real-time payment at a depository bank. The system may include a memory storing instructions and one or more processors configured to execute instructions to serially send, to one or more financial institutions via a communication network, a plurality of inquiry requests, wherein each inquiry request comprises a financial instrument that is being presented for deposit at a depository bank. The one or more processors may also be configured to serially receive, from the one or more financial institutions via the communication network, a plurality of inquiry responses, wherein each inquiry response is received in real time in response to one respective inquiry request being sent, and wherein each inquiry response comprises a payment guarantee decision, the payment guarantee decision specifying whether the payment for the financial instrument is or is not guaranteed. In addition, the one or more processors may be configured to serially send, to the one or more financial institutions via the communication network, a plurality of completion requests to the financial institution, wherein each completion request is received in real time in response to one of the plurality of inquiry responses being received. The one or more processors may also be configured to serially receive, from the one or more financial institutions via the communication network, a plurality of completion responses, wherein each completion response is received in real time in response to one of the plurality of completion requests being sent. Further, the one or more processors may also be configured to serially post the plurality of financial instruments of the plurality of inquiry responses for the deposit into one or more financial accounts, wherein each financial instrument is posted based on at least one of the plurality of the payment guarantee decisions and one of the plurality of completion responses.

Moreover, a method is provided, consistent with the disclosed embodiments, for electronically processing a real-time payment at a depository bank. The method may include one or more of the steps of: serially sending, to one or more financial institutions via a communication network, a plurality of inquiry requests, wherein each inquiry request comprises a financial instrument that is being presented for deposit at a depository bank; serially receiving, from the one or more financial institutions via the communication network, a plurality of inquiry responses, wherein each inquiry response is received in real time in response to one respective inquiry request being sent, and wherein each inquiry response comprises a payment guarantee decision, the payment guarantee decision specifying whether the payment for the financial instrument is or is not guaranteed; serially sending, to the one or more financial institutions via the communication network, a plurality of completion requests to the financial institution, wherein each completion request is received in real time in response to one of the plurality of inquiry responses being received; serially receiving, from the one or more financial institutions via the communication network, a plurality of completion responses, wherein each completion response is received in real time in response to one of the plurality of completion requests being sent; and serially posting the plurality of financial instruments of the plurality of inquiry responses for the deposit into one or more financial accounts, wherein each financial instrument is posted based on at least one of the plurality of the payment guarantee decisions and one of the plurality of completion responses.

In addition, consistent with disclosed embodiments, an orchestration layer for electronically processing a real-time payment at a paying bank is provided. The orchestration layer may include a paying bank service. The paying bank service may include one or more of: an inquiry module for processing an inquiry request and sending an inquiry response, the inquiry module comprising a first memory and a first processor; a completion module for processing a completion request and sending a completion response, the completion module comprising a second memory and a second processor; a notification module for processing a notification request and sending a notification response, the notification module comprising a third memory and a third processor; and a reversal module for processing a reversal request and sending a reversal response, the reversal module comprising a fourth memory and a fourth processor.

Moreover, consistent with disclosed embodiments, an orchestration layer for electronically processing a real-time payment at a depository bank is provided. The orchestration layer may include a depository bank service. The depository bank service may include one or more of: an inquiry module for processing an inquiry request and sending an inquiry response, the inquiry module comprising a first memory and a first processor; a completion module for processing a completion request and sending a completion response, the completion module comprising a second memory and a second processor; a notification module for processing a notification request and sending a notification response, the notification module comprising a third memory and a third processor; and a reversal module for processing a reversal request and sending a reversal response, the reversal module comprising a fourth memory and a fourth processor.

Aspects of the disclosed embodiments may include tangible and non-transitory computer readable media that store software instructions that, when executed by one or more processors, are configured for and capable of performing and executing one or more of the methods, operations, and the like, consistent with the disclosed embodiments.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a schematic diagram illustrating an exemplary system environment to enable real-time inquiries regarding a financial instrument, consistent with disclosed embodiments.

FIG. 2 is a diagram of an exemplary orchestration layer to perform functions of the disclosed methods, consistent with disclosed embodiments.

FIG. 3 is a flowchart of an exemplary process for electronically receiving and processing an inquiry request at a depository bank, consistent with disclosed embodiments.

FIG. 4 is a flowchart of an exemplary process for electronically receiving and processing a completion request at a depository bank, consistent with disclosed embodiments.

FIG. 5 is a flowchart of an exemplary process for electronically receiving and processing a notification request at a depository bank, consistent with disclosed embodiments.

FIG. 6 is a flowchart of an exemplary process for electronically receiving and processing a reversal request at a depository bank, consistent with disclosed embodiments.

FIG. 7 is a flowchart of an exemplary process for electronically receiving and processing an inquiry request at a paying bank, consistent with disclosed embodiments.

FIG. 8 is a flowchart of an exemplary process for electronically receiving and processing a completion request at a paying bank, consistent with disclosed embodiments.

FIG. 9 is a flowchart of an exemplary process for electronically receiving and processing a notification request at a paying bank, consistent with disclosed embodiments.

FIG. 10 is a flowchart of an exemplary process for electronically receiving and processing a reversal request at a paying bank, consistent with disclosed embodiments.

FIG. 11 is an illustrative example of processing a financial instrument using the orchestration layer, consistent with disclosed embodiments.

FIG. 12 is a diagram of an exemplary screen that may be presented on a terminal, consistent with disclosed embodiments.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

Generally, disclosed embodiments are directed to systems and techniques for a computerized orchestration layer that allows financial institutions (such as banks) to make real-time inquiries to other financial institutions when presented with a financial instrument. For example, embodiments may be described in connection with cashing against or depositing into financial accounts (e.g., checking accounts, savings accounts, money market deposit accounts, etc.). Moreover, embodiments may also be described in connection with financial instruments (e.g., checks, personal checks, business checks, certified checks, bearer check, cashier's checks, traveler's checks, etc.). Further, steps or processes disclosed herein are not limited to being performed in the order described but may be performed in any order, and some steps may be omitted, consistent with the disclosed embodiments. It is also understood that any reference regarding a customer providing a financial instrument for deposit may also apply to a customer providing a financial instrument for cash.

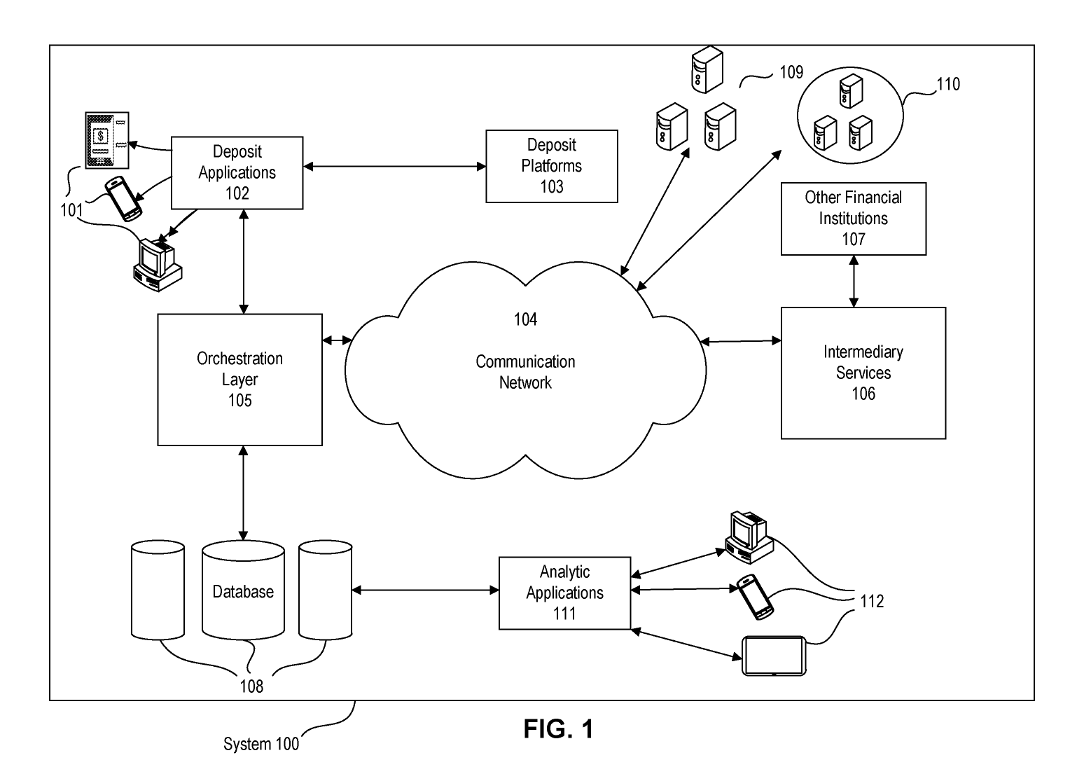

FIG. 1 is a schematic diagram illustrating an exemplary system environment to enable real-time inquiries regarding a financial instrument, consistent with disclosed embodiments. In particular, FIG. 1 shows a diagram of an exemplary system 100, consistent with disclosed embodiments, revealing some technical aspects of the present disclosure for achieving the intended results of the present disclosure. Referring to FIG. 1, system 100 may include customer terminal(s) 101, deposit application(s) 102, deposit platform(s) 103, communication network 104, and orchestration layer 105, intermediary service(s) 106, other financial institution(s) 107, database(s) 108, server cluster(s) 109, cloud server(s) 110, analytic application(s) 111, and analyzer terminal(s) 112. The components and arrangement of the components included in system 100 may vary. Thus, system 100 may further include other components or devices that perform or assist in the performance of one or more processes consistent with the disclosed embodiments. The components and arrangements shown in FIG. 1 are not intended to limit the disclosed embodiments, as the components used to implement the disclosed processes and features may vary.

As shown in FIG. 1, a plurality of customer terminal(s) 101 may be implemented using a variety of different equipment, such as supercomputers, personal computers, servers, mainframes, mobile devices, smartphones, tablets, etc. In some embodiments, customer terminal(s) 101 may be associated with a financial institution. Furthermore, in some embodiments, customer terminal(s) 101 may be a machine or kiosk such as an automated teller machine (ATM). In some embodiments, customer terminal(s) 101 may be configured to receive input from a customer, such as input regarding a financial transaction (e.g., a deposit transaction, withdrawal transaction, balance, etc.). For example, customer terminal(s) 101 may execute a web browser application to present a web page through which a customer may submit a financial transaction. Customer terminal(s) 101 may send that inputted data (e.g., a financial transaction) to orchestration layer 105 for processing. In some embodiments, customer terminal(s) 101 may accept a physical, financial instrument through a reader (e.g., a check reader, camera, scanner, etc.), extract information, and send the extrapolated plurality of information to orchestration layer 105.

In some embodiments, customer terminal(s) 101 may be a physical location of a financial institution (e.g., a bank, an office, a department providing financial services, etc.) or a remote location (e.g., a call center for the financial institution, etc.). In some embodiments, an employee representing the financial institution may input a plurality of information from the financial instrument given by a customer. Furthermore, in some embodiments, an employee representing the financial institution may assist with the inputting of the plurality of information from the financial instrument given by the customer.

Deposit application(s) 102, in some embodiments, may be a part of customer terminal(s) 101. In some embodiments, deposit application(s) 102 may be separate from customer terminal(s) 101. For example, deposit application(s) 102 may be implemented using a variety of different equipment, such as supercomputers, personal computers, servers, mainframes, mobile devices, smartphones, tablets, etc. In some embodiments, an employee representing the financial institution may input a plurality of information from the financial instrument given by a customer. Furthermore, in some embodiments, an employee representing the financial institution may assist with the inputting of the plurality of information from the financial instrument given by the customer. In some embodiments, customer terminal(s) 101 and/or deposit application(s) 102 may require a customer to satisfy one or more security measures. For example, a customer may be required to input or speak a password, social security number, an account number, or the like. As another example, a customer may be required to enter biometric data such as a fingerprint or an eye scan. A customer may be required to also enter or select a pattern of images, spoken words, text, or the like. Even further, as an example, a customer may be required to answer security questions or complete various anti-hacking or cracking security measures such reCAPTCHA™. In some embodiments, after satisfying one or more security measures, customer terminal(s) 101 may associate the customer with a financial account and accept the financial instrument for deposit into that financial account.

Deposit platform(s) 103, in some embodiments, may be implemented using a variety of different equipment, such as supercomputers, personal computers, servers, mainframes, mobile devices, smartphones, tablets, etc. In some embodiments, deposit platform(s) 103 may comprise hardware, software, and/or firmware modules. In some embodiments, deposit platform(s) 103 may be used by customer terminal(s) 101 and/or deposit application(s) 102 to accept a financial instrument for deposit into a financial account. For example, customer terminal(s) 101 and/or deposit application(s) 102 may use an intermediary process or an application program interface (API), whether representational state transfer (RESTful) or not, to send the financial instrument or the plurality of information from the financial instrument to deposit platform(s) 103 over communication network 104. In some embodiments, deposit platform(s) have the ability to update the financial account information using the plurality of information from the financial instrument (e.g., updating an account balance, list of transactions, etc.).

Further, in some embodiments, deposit platform(s) 103 may update the customer regarding the updated financial account information. For example, deposit platform(s) 103 may send a customer an update using electronic messaging, such as text, email, or the like. In some embodiments, deposit platform(s) 103 may cause a physical mailing to be mailed to the customer. In some embodiments, deposit platform(s) 103 may cause customer terminal(s) 101 and/or deposit application(s) 102 to update the customer. For example, deposit platform(s) 103 may cause customer terminal(s) 101 and/or deposit application(s) 102 to display the updated information to the customer or send a customer an update using electronic messaging, such as text, email, or the like.

Communication network 104, in some embodiments, may comprise one or more interconnected wired or wireless data networks that receive data from one service or device (e.g., orchestration layer 105) and send it to another service or device (e.g., deposit application(s) 102, deposit platform(s) 103, an intermediary service 106, other financial institution(s) 107, database(s) 108, server cluster(s) 109, cloud server(s) 110, analytic application(s) 111, analyzer terminal(s) 112). For example, computer network 104 may be implemented as one or more of the Internet, a wired Wide Area Network (WAN), a wired Local Area Network (LAN), a wireless LAN (e.g., IEEE 802.11, Bluetooth, etc.), a wireless WAN (e.g., WiMAX), and the like. Each component in system 100 may communicate bidirectionally with other system 100 components either through computer network 104 or through one or more direct communication links (not all are shown).

Orchestration layer 105 may be implemented using different equipment, such as one or more supercomputers, one or more personal computers, one or more servers (e.g., server clusters 109 and/or cloud service 110), one or more mainframes, one or more mobile devices, or the like. In some embodiments, orchestration layer 105 may comprise hardware, software, and/or firmware modules. Orchestration layer 105 may be configured to allow financial institutions to make real-time inquiries to other financial institutions when presented with a financial instrument. For example, orchestration layer 105 may be used by a depository bank, enabling the capability of electronically receiving and processing of an immediate payment guarantee response when a financial instrument drawn on a paying bank is presented for deposit into the depository bank. As another example, orchestration layer 105 may be used by a paying bank, enabling the capability of electronically providing an immediate payment guarantee response for a financial instrument drawn on the paying bank when a request to guarantee that financial instrument is received from another financial institution.

Intermediary service 106, in some embodiments, may be used to facilitate or send responses and requests between orchestration layer 105 and other financial institution(s) 107. In some embodiments, various information (e.g., financial instrument information, a payment decision guarantee, financial account information, financial transaction information, etc.) may also be sent and received between orchestration layer 105 and other financial institution(s) 107 via intermediary service 106. Further, intermediary service 106, in some embodiments, may be implemented using Early Warning® Services (EWS) or another commercial intermediary service. In some embodiments, the intermediary service may require a particular type of response or request to transmit the response or request between orchestration layer 105 and other financial institution(s) 107. For example, the custom response or request may be written using Extensible Markup Language (XML) and require a particular XML structure for the information that needs to be transmitted by orchestration layer 105 and/or other financial institution(s) 107. In some embodiments, a plurality of predetermined techniques is available for use with intermediary service 106. In some embodiments, intermediary service 106 may be communicated via computer network 104 by using an API. For example, orchestration layer 105 may call an API or a particular function of the API to send a request, response, or information to the other financial institution(s) through intermediary service 106.

Further, in some embodiments, the transmitted information may be transformed, using an Extensible Stylesheet Language Transformations (XSLT), into XML. As another example, in some embodiments, a response or request may be serialized and encrypted while requiring orchestration layer 105 and/or other financial institution(s) 107 to transmit a secret key in order for intermediary service 106 to transmit and read the information that needs to be transmitted by orchestration layer 105 and/or other financial institution(s) 107. None of these examples are limiting. It should be understood that a particular type of response or request might be structured in any way that the intermediary service 106 requires using a number of different types of technology components in a number of different ways.

Other financial institution(s) 107, in some embodiments, may include a main location (e.g., a bank, an office, a department providing financial services, etc.) or remote location (e.g., a call center for the financial institution, etc.). In some embodiments, other financial institution(s) 107 may communicate with orchestration layer 105 using communication network 104. In some embodiments, other financial institution(s) may have technology services that communicate with orchestration layer 105 or intermediary service 106 via communication network 104. These technology services may be implemented using a variety of different equipment, such as supercomputers, personal computers, servers, mainframes, mobile devices, smartphones, tablets, etc.

Database(s) 108 may be configured to store information consistent with the disclosed embodiments. In some aspects, components of system 100 (shown and not shown) may be configured to receive, obtain, gather, collect, generate, or produce information to store in database(s) 108. In certain embodiments, for instance, components of system 100 may receive or obtain information for storage over communications network 104. By way of example, database(s) 108 may store financial account information associated with a customer, financial transactions associated with a customer, and customer information. In another example, database(s) 108 may store responses produced by and requests to orchestration layer 105. In other aspects, components of system 100 may store information in database(s) 108 without using a computer network 104 (e.g., via a direct connection). In some embodiments, components of system 100, including but not limited to orchestration layer 105, may use information stored within database(s) 108 for processes consistent with the disclosed embodiments.

Server cluster(s) 109 may be located in the same data center or different physical locations. Multiple server clusters 109 may be formed as a grid to share resources and workloads. Each server cluster 109 may include a plurality of linked nodes operating collaboratively to run various applications, software modules, analytical modules, rule engines, etc. Each node may be implemented using a variety of different equipment, such as a supercomputer, personal computer, a server, a mainframe, a mobile device, or the like. In some embodiments, the number of servers and/or server cluster(s) 109 may be expanded or reduced based on workload. In some embodiments, one or more components of orchestration layer 105 (including one or more server cluster(s) 109) may be placed behind a load balancer to support high availability and ensure real-time (or near real-time) processing of optimal decision predictions, consistent with disclosed embodiments.

Cloud service 110 may include a physical and/or virtual storage system associated with cloud storage for storing data and providing access to data via a public network such as the Internet. Cloud service 110 may include cloud services such as those offered by, for example, Amazon®, Apple®, Cisco®, Citrix®, IBM®, Joyent®, Google®, Microsoft®, Rackspace®, Salesforce.com®, and VerizonaTerremark®, or other types of cloud services accessible via communication network 104. In some embodiments, cloud service 110 comprises multiple computer systems spanning multiple locations and having multiple databases or multiple geographic locations associated with a single or multiple cloud storage service(s). As used herein, cloud service 110 refers to physical and virtual infrastructure associated with a single cloud storage service. In some embodiments, cloud service 110 manages and/or stores data associated with allowing financial institutions to make real-time inquiries to other financial institutions when presented with a financial instrument.

Analytic application(s) 111 may be implemented using a variety of different equipment, such as supercomputers, personal computers, servers, mainframes, mobile devices, smartphones, tablets, etc. In some embodiments, analytic application(s) 111 may comprise hardware, software, and/or firmware modules. In some embodiments, analytic application(s) 111 uses stored data (e.g., stored responses and requests generated and/or received by orchestration layer 105 in database(s) 108 to deliver analytics to an analyzer (e.g., an employee of a bank, a consultant, a firm, a software program, etc.). In some embodiments, analytic application(s) 111 uses APIs from other commercial technology services (e.g., Tableau™) to analyze stored data. In some embodiments, the commercial technology service uses a Java® Database Connectivity connector to directly read the data from database(s) 108 to present information to analyzer terminal(s) 112. In some embodiments, analytic application(s) 111 may cause analyzer terminal(s) 112 to update the analyzer.

Analyzer terminal(s) 112 may be used to view analytics from analytic application(s) 111. Analyzer terminal(s) 112 may be implemented using a variety of different equipment, such as supercomputers, personal computers, servers, mainframes, mobile devices, smartphones, tablets, etc. In some embodiments, analyzer terminal(s) 112 may be configured to receive input from an analyzer of the financial institution, such as input regarding statistics for financial transactions. For example, analyzer terminal(s) 112 may execute a web browser application to present a web page through which an analyzer may submit a request for statistics regarding stored responses and requests of orchestration layer 105. Analyzer terminals 112 may send that inputted data (e.g., request for statistics) to the analytic application(s) 111 for processing.

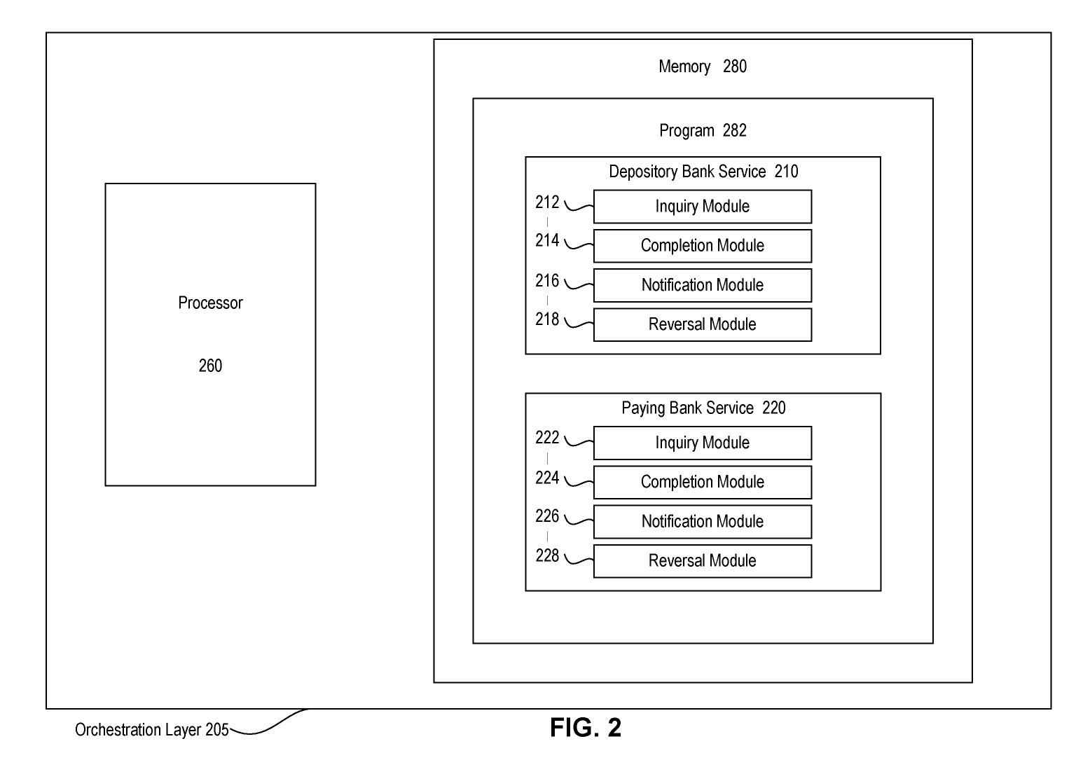

FIG. 2 is a diagram of an exemplary orchestration layer 105 to perform functions of the disclosed methods, consistent with disclosed embodiments. As shown, orchestration layer 105 may include one or more processors 260, memory 280 storing data and programs 282 (including, for example, depository bank service 210, having inquiry module(s) 212, completion module(s) 214, notification module(s) 216, and reversal module(s) 218, and paying bank service 220, having inquiry module(s) 222, completion module(s) 224, notification module(s) 226, and reversal module(s) 228). As noted above, orchestration layer 105 may be a single server or may be configured as a distributed computer system including multiple servers or computers (e.g., server clusters 109 and/or cloud service 110) that interoperate to perform one or more of the processes and functionalities associated with the disclosed embodiments. In some embodiments, orchestration layer 105 is specially configured with hardware and/or software modules for performing functions of disclosed methods. The modules may be implemented as specialized circuitry integrated within processor(s) 260 or in communication with processor(s) 260, and/or specialized software stored in memory 280 (as depicted in FIG. 2) executable by processor(s) 260.

Processor(s) 260 may be one or more known or custom processing devices designed to perform functions of the disclosed methods, such as a single core or multiple core processors capable of executing parallel processes simultaneously. For example, processor(s) 260 may be configured with virtual processing technologies. In certain embodiments, processor(s) 260 may use logical processors to execute and control multiple processes simultaneously. Processor(s) 260 may implement virtual machine technologies, including a Java virtual machine, or other known technologies to provide the ability to execute, control, run, manipulate, store, etc., multiple software processes, applications, programs, etc. In another embodiment, processor(s) 260 may include a multiple-core processor arrangement (e.g., dual core, quad core, etc.) configured to provide parallel processing functionalities to allow orchestration layer 105 to execute multiple processes simultaneously. One of ordinary skill in the art would understand that other types of processor arrangements may be implemented that provide for the capabilities disclosed herein.

Orchestration layer 105 may include one or more storage devices configured to store information used by processor(s) 260 (or other components) to perform certain functions related to the disclosed embodiments. In one example, orchestration layer 105 may include memory 280 that includes instructions to enable processor(s) 260 to execute one or more applications, such as depository bank service 210, paying bank service 220, server applications, network communication processes, and any other type of application or software known to be available on computer systems. Alternatively or additionally, the instructions, application programs, etc., may be stored in an internal database or external storage (not shown) in direct communication with orchestration layer 105, such as one or more database or memory accessible over computer network 104. The internal database and external storage may be a volatile or non-volatile, magnetic, semiconductor, tape, optical, removable, non-removable, or another type of storage device or tangible (i.e., non-transitory) computer-readable medium.

Orchestration layer 105 may also be communicatively connected to one or more remote memory devices (e.g., remote databases (not shown)) through computer network 104 or a different network. The remote memory devices may be configured to store information (e.g., structured, semi-structured, and/or unstructured data) and may be accessed and/or managed by orchestration layer 105. By way of example, the remote memory devices may be document management systems, Microsoft® SQL databases, SharePoint® databases, Oracle® databases, Sybase™ databases, or other relational databases. Systems and techniques consistent with disclosed embodiments, however, are not limited to separate databases or even to the use of a database.

In one embodiment, orchestration layer 105 may include memory 280 that includes instructions that, when executed by processor(s) 260, perform one or more processes consistent with the functionalities disclosed herein. Methods, systems, and articles of manufacture consistent with disclosed embodiments are not limited to separate programs or computers configured to perform dedicated tasks. For example, orchestration layer 105 may include memory 280 that may include one or more programs 282 and/or orchestration layer(s) 105 to perform one or more functions of the disclosed embodiments. Moreover, processor(s) 260 may execute one or more programs located remotely from system 100. For example, orchestration layer 105 may access one or more remote programs, that, when executed, perform functions related to disclosed embodiments.

Memory 280 may include one or more memory devices that store data and instructions used to perform one or more features of the disclosed embodiments. For example, memory 280 may represent a tangible and non-transitory computer-readable medium having stored therein computer programs, sets of instructions, code, or data to be executed by processor(s) 260. Memory 280 may include, for example, a removable memory chip (e.g., EPROM, RAM, ROM, DRAM, EEPROM, flash memory devices, or other volatile or non-volatile memory devices) or other removable storage units that allow instructions and data to be accessed by processor(s) 260.

Memory 280 may also include any combination of one or more relational and/or non-relational databases controlled by memory controller devices (e.g., server(s), etc.) or software, such as document management systems, Microsoft® SQL databases, SharePoint® databases, Oracle® databases, Sybase™ databases, or other relational databases, or non-relational databases such as key-value stores, graph databases such as OrientDB™, or NOSQL™ databases such as Apache HBase™. In some embodiments, memory 280 may comprise an associative array architecture, such as a key-value storage, for storing and rapidly retrieving large amounts of information.

Programs 282 stored in memory 280 and executed by processor(s) 260 may include one or more services and modules arranged in a variety of ways. In some embodiments, modules may be combined with one another. In other embodiments, modules may be separate from one another. The number of arrangements is not limited.

Consistent with disclosed embodiments, orchestration layer 105 may execute one or more services, such as those depicted in FIG. 2. Consistent with disclosed embodiments, depository bank service 210 may communicate with a depository bank, enabling the capability of electronically receiving and processing an immediate payment guarantee response when a financial instrument, drawn on a paying bank, is presented for deposit into a depository bank. For example, a depository bank may use depository bank service 210 to receive and process one or more requests/responses including inquiry requests/responses via inquiry module(s) 212, completion requests/responses via completion module(s) 214, notification requests/responses via notification module(s) 216, and reversal requests/responses via reversal module(s) 218.

Paying bank service 220, consistent with disclosed embodiments, may communicate with a paying bank, enabling the capability of electronically providing an immediate payment guarantee response for a financial instrument drawn on a paying bank when a request to guarantee that financial instrument is received from another financial institution. For example, a paying bank may use paying bank service 220 to receive and process one or more requests/responses including inquiry requests/responses via inquiry module(s) 222, completion requests/responses via completion module(s) 224, notification requests/responses via completion module(s) 226, and reversal requests/responses via completion module(s) 228.

In some embodiments, inquiry module(s) 212 may be included in depository bank service 210. In some embodiments, inquiry module(s) 212 may be implemented separately from other modules. Inquiry module(s) 212 may contain instructions that, when executed by processor(s) 260, process when depository bank service 210 receives an inquiry request when the depository bank wants to find out if payment of a financial instrument being presented for the deposit may be guaranteed by a paying bank. In some embodiments, customer terminal(s) 101 may cause inquiry module(s) 212 to receive an inquiry request. In some embodiments, an inquiry request is initiated internally by depository bank service 210 or sent by some other external process.

In some embodiments, completion module(s) 214 may be included in depository bank service 210. In some embodiments, completion module(s) 214 may be implemented separately from other modules. Completion module(s) 214 may contain instructions that, when executed by processor(s) 260, process when depository bank service 210 receives a completion request when a depository bank wants to provide a message that the depository bank is accepting the financial instrument being presented for deposit based on the payment guarantee decision returned in a previous response to an inquiry response. In some embodiments, the depository bank may want to provide a message that the depository bank is accepting the financial instrument being presented for deposit despite the payment guarantee decision returned in a previous response to an inquiry response after receiving a completion request. Further, in some embodiments, the depository bank may submit the completion request even if the previous payment guarantee decision stored by inquiry module(s) 212 does not indicate that it is guaranteed. In some embodiments, customer terminal(s) 101 may cause completion module(s) 214 to receive a completion request. In some embodiments, a completion request is initiated internally by a depository bank or sent by some other external process.

In some embodiments, notification module(s) 216 may be included in depository bank service 210. In some embodiments, notification module(s) 216 may be implemented separately from other modules. Notification module(s) 216 may contain instructions that, when executed by processor(s) 260, process when depository bank service 210 receives a completion request when a depository bank wants to provide a message that the depository bank is accepting a financial instrument that is being presented for deposit and a payment guarantee decision is not needed. In some embodiments, customer terminal(s) 101 may cause notification module(s) 216 to receive a notification request. In some embodiments, a notification request is initiated internally by a depository bank or sent by some other external process.

In some embodiments, reversal module(s) 218 may be included in depository bank service 210. In some embodiments, reversal module(s) 218 may be implemented separately from other modules. Reversal module(s) 218 may contain instructions that, when executed by processor(s) 260, process when depository bank service 210 receives a reversal request when a depository bank does not want to accept a deposited financial instrument that the depository bank previously provided a notification response or a completion response indicating acceptance. In some embodiments, customer terminal(s) 101 may cause reversal module(s) 218 to receive a reversal request. In some embodiments, a reversal request is initiated internally by a depository bank or sent by some other external process.

In some embodiments, inquiry module(s) 222 may be included in paying bank service 220. In some embodiments, inquiry module(s) 222 may be implemented separately from other modules. Inquiry module(s) 222 may contain instructions that, when executed by processor(s) 260, process when paying bank service 220 receives an inquiry request when a financial institution wants to find out if a paying bank will guarantee payment of a financial instrument being presented for deposit to a customer at the financial institution. In some embodiments, a depository bank may cause inquiry module(s) 222 to receive an inquiry request. In some embodiments, an inquiry request is initiated internally by paying bank service 220 or sent by some other external process.

In some embodiments, completion module(s) 224 may be included in paying bank service 220. In some embodiments, completion module(s) 224 may be implemented separately from other modules. Completion module(s) 224 may contain instructions that, when executed by processor(s) 260, process when paying bank service 220 receives a completion request when a financial institution wants to confirm that the paying bank is paying a financial instrument being presented for deposit based on the payment guarantee decision returned in a previous response to an inquiry response. In some embodiments, the financial institution may want to provide a message that the financial institution is accepting a financial instrument being presented for deposit despite the payment guarantee decision returned in a previous response to an inquiry response after receiving a completion request. Further, in some embodiments, the financial institution may submit the completion request even if the previous payment guarantee decision stored by inquiry module(s) 212 does not indicate that it is guaranteed. In some embodiments, the completion response 224 will be provided regardless. Completion module(s) 224 will only, in some embodiments, be provided by the financial institution if the financial institution is accepting the deposit. In some embodiments, a depository bank may cause inquiry module(s) 224 to receive a completion request. In some embodiments, a completion request is initiated internally by paying bank service 220 or sent by some other external process.

In some embodiments, notification module(s) 226 may be included in paying bank service 220. In some embodiments, notification module(s) 226 may be implemented separately from other modules. Notification module(s) 226 may contain instructions that, when executed by processor(s) 260, process when paying bank service 220 receives a completion request when a paying bank wants to provide a message that the paying bank is paying a financial instrument that is being presented for deposit and a payment guarantee decision is not needed. In some embodiments, a depository bank may cause notification module(s) 226 to receive a notification request. In some embodiments, a notification request is initiated internally by paying bank service 220 or sent by some other external process.

In some embodiments, reversal module(s) 228 may be included in paying bank service 220. In some embodiments, reversal module(s) 228 may be implemented separately from other modules. Reversal module(s) 228 may contain instructions that, when executed by processor(s) 260, process when paying bank service 220 receives a reversal request when a paying bank does not want to pay financial instrument to which the paying bank previously provided a notification response or completion response indicating acceptance. In some embodiments, a depository bank may cause reversal module(s) 228 to receive a reversal request. In some embodiments, a reversal request is initiated internally by paying bank service 220 or sent by some other external process.

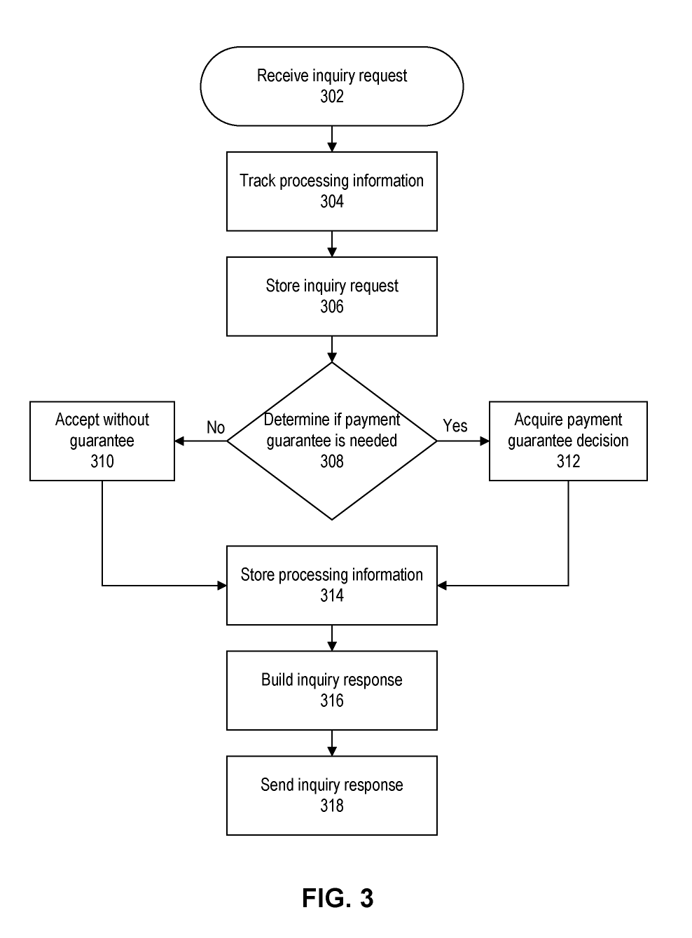

FIG. 3 is a flowchart of an exemplary process for electronically receiving and processing an inquiry request at a depository bank, consistent with disclosed embodiments. In some embodiments of FIG. 3, an inquiry request may indicate that a customer of a depository bank wants to find out if payment of a financial instrument being presented for the deposit may be guaranteed by a paying bank. In some embodiments, customer terminal(s) 101 sends an inquiry request to inquiry module(s) 212.

At step 302, consistent with disclosed embodiments, inquiry module(s) 212 may receive an inquiry request from a depository bank via communication network 104. In some embodiments, the inquiry request may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, an inquiry request has been received from a depository bank. In some embodiments, intermediary service 106 may act as an intermediary application, server, etc., between depository bank and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 302.

Consistent with disclosed embodiments, at step 304, inquiry module(s) 212 may track a plurality of processing information. In some embodiments, Step 304 may comprise inquiry module(s) 212 tracking a plurality of processing information in various ways. For example, in some embodiments, inquiry module(s) 212 may track the plurality of processing information by printing a plurality of tracking information to a log file. As another example, inquiry module(s) 212 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 306, consistent with disclosed embodiments, inquiry module(s) 212 may store a request into database 108. In some embodiments, the request is stored as an inquiry log record in database 108. In some embodiments, the log record contains other information. For example, the log record may contain a plurality of tracking information, errors, request(s), date(s), other response(s), etc.

At step 308, consistent with disclosed embodiments, inquiry module(s) 212 may determine whether a payment guarantee decision is needed. For example, in some embodiments, determining whether a payment guarantee decision is needed may involve determining whether the deposit amount of the financial instrument is less than a threshold amount. The threshold amount may be represented in various ways. In some embodiments, the threshold amount is a numerical value representing a monetary amount or fiat currency amount, such as $100.00, £3000.55, etc. In some embodiments, the threshold amount is a percentage of the money in the depository account. For example, a threshold amount may equal 5% of the money in the depository account. In some embodiments, the threshold amount is an equation, which is dependent on the depository amount. As another example, in some embodiments, determining whether a payment guarantee decision is needed may involve determining whether the paying bank of the financial instrument is on a ban or accept list. In some embodiments, determining whether a payment guarantee decision is needed may involve determining whether the financial instrument is associated with a financial account is on a ban list. Many other examples exist to determine whether a payment guarantee decision is needed and the above examples do not limit the possibilities of one of ordinary skill in the art.

Consistent with disclosed embodiments, at step 310 if inquiry module(s) 212 determines that the deposit will be accepted without guarantee, inquiry module(s) 212 may accept the financial instrument for deposit. In some embodiments, inquiry module(s) 212 will cause depository bank service 210 to accept the financial instrument for the deposit with standard Funds Availability. In some embodiments, a notification indicating that the financial instrument for deposit has been accepted is sent to the depository institution (e.g., a notification stating “Financial Instrument for Deposit Accepted”). In some embodiments, inquiry module(s) 212 will cause depository bank service 210 to send a notification request to a paying bank. Further, in some embodiments, the payment guarantee decision is determined to indicate that the financial instrument has been accepted without payment guarantee. For example, in some embodiments, the payment guarantee decision may indicate that the financial instrument has been accepted without payment guarantee decision by setting the payment guarantee decision to “Financial Instrument for Deposit Accepted Without Guarantee.”

At step 312, consistent with disclosed embodiments, if inquiry module(s) 212 determines that the deposit will not be accepted without guarantee, inquiry module(s) 212 may acquire a payment guarantee decision from the paying institution. In some embodiments, inquiry module(s) 212 acquires a payment guarantee decision by sending a different inquiry request to a paying bank or other financial institution(s) 107. In some embodiments, inquiry module(s) 212 uses intermediary service 106 to send the different inquiry request to a paying bank or other financial institution(s) 107. For example, in some embodiments, inquiry module(s) 212 may call an API of intermediary service 106 to send the different inquiry request to a paying bank or other financial institution(s) 107. In some embodiments, the different inquiry request may be built according to a predetermined technology schedule of intermediary service 106. In some embodiments, the response transmitted is consistent with a predetermined technology scheme using technology such as XML or XML using XSLT of a commercial intermediary service. The payment guarantee decision may be received from a paying bank or other financial institution(s) 107, in some embodiments, by the inquiry module(s) 212. In some embodiments, the inquiry module(s) 212 receives the response from a paying bank or other financial institution(s) 107 via intermediary service 106 in a predetermined structure of intermediary service 106.

In some embodiments, if the received payment guarantee decision indicates that the payment is guaranteed, inquiry module(s) 212 may cause depository bank service 210 to accept the deposit with either a standard or expanded Funds Availability. In some embodiments, accepting the deposit with an expand Funds Availability means providing to a customer, for example, a greater amount of funds, the funds in a shorter amount of time, etc., than the standard Funds Availability.

In other embodiments, if the received payment guarantee decision indicates that the payment is not guaranteed, inquiry module(s) 212 may cause depository bank service 210 to accept the deposit with either a standard or reduced Funds Availability. In some embodiments, accepting the deposit with a reduced Funds Availability means providing to a customer, for example, a lesser amount of funds, the funds in a longer amount of time, etc., than the standard Funds Availability.

In some other embodiments, if the received payment guarantee decision indicates that an error has occurred or no comment may be provided, inquiry module(s) 212 may cause depository bank service 210 to accept the deposit with a standard Funds Availability.

Consistent with disclosed embodiments, at step 314, inquiry module(s) 212 may store a plurality of processing information into a database. In some embodiments, the stored plurality of processing information comprises all of the plurality of processing information from step 304. In some embodiments, only a fraction of the plurality of processing information from step 304 is stored. In some embodiments, extracted response(s) and request(s) are stored. Raw response(s) and request(s) are stored, in some embodiments. Further, in some embodiments, the payment guarantee decision that may be received from a paying bank is stored.

At step 316, consistent with disclosed embodiments, inquiry module(s) 212 may build a response having a payment guarantee decision. In some embodiments, an inquiry response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the inquiry response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 318. At step 318, inquiry module(s) 212 may send the response to the depository bank via communication network 104.

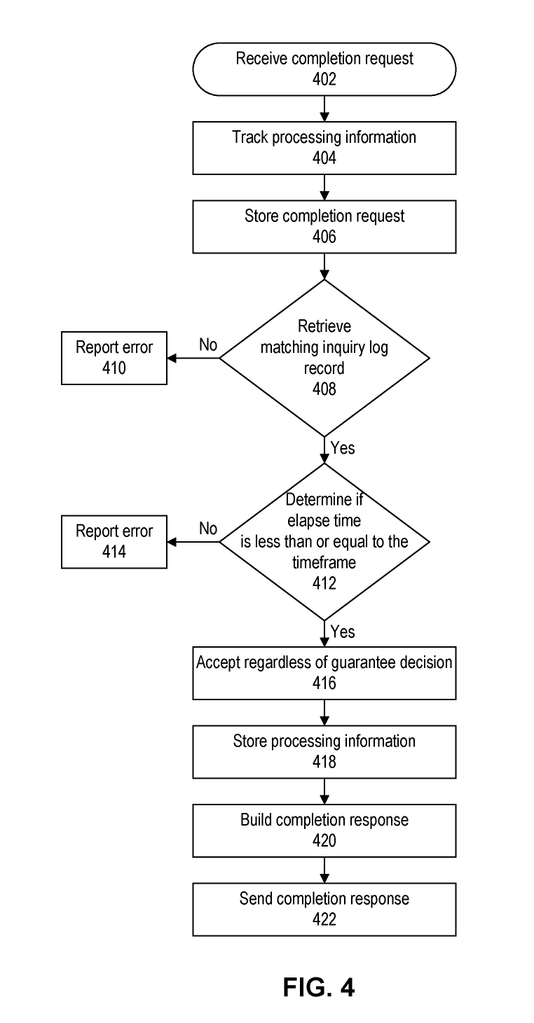

FIG. 4 is a flowchart of an exemplary process for electronically receiving and processing a completion request at a depository bank, consistent with disclosed embodiments. A completion request, in some embodiments of FIG. 4, may indicate that depository bank service 210 wants to provide a message that the depository bank is accepting the financial instrument being presented for deposit based on the payment guarantee decision returned in a previous response to an inquiry response. In some embodiments of FIG. 4, a completion request may indicate that the depository bank service 210 may want to provide a message that the depository bank is accepting the financial instrument being presented for deposit despite the payment guarantee decision returned in a previous response to an inquiry response after receiving a completion request. In some embodiments, customer terminal(s) 101 sends a completion request to completion module(s) 214.

At step 402, consistent with disclosed embodiments, completion module(s) 214 may receive a completion request from a depository bank via communication network 104. In some embodiments, the completion request may contain a financial instrument having a plurality of financial account information. In some embodiments, a completion request has been received from depository bank 210. In some embodiments, intermediary service 106 may act as an intermediary between depository bank service 210 and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 402.

Consistent with disclosed embodiments, at step 404, completion module(s) 214 may track a plurality of processing information. In some embodiments, completion module(s) 214 may track a plurality of processing information in various ways. For example, in some embodiments, completion module(s) 214 may track the plurality of processing information by printing a plurality of tracking information to a log file. As another example, completion module(s) 214 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 406, consistent with disclosed embodiments, completion module(s) 214 may store a request into database 108. In some embodiments, the request is stored as a completion log record in database 108. In some embodiments, the log record contains other information. For example, the log record may contain a plurality of tracking information, errors, request(s), date(s), other response(s), etc.

At step 408, consistent with disclosed embodiments, completion module(s) 214 may determine a completion response message. In some embodiments, completion module(s) 214 may retrieve an inquiry log record that matches or corresponds to the completion request received by step 402. In some embodiments, completion module(s) 214 may search database 108 using key data elements to find a matching inquiry log record. As an example, in some embodiments, key data elements used to search database 108 may be one or more of an account number, a date, a timeframe, etc.

At step 410, consistent with disclosed embodiments, if an inquiry log record that matches or corresponds to the completion request cannot be retrieved, in some embodiments, completion module(s) 214 may determine the completion response to indicate that an error has occurred. In some embodiments, completion module(s) 214 may determine the completion response to indicate that the matching inquiry log record cannot be retrieved. For example, in some embodiments, the completion response message may indicate that the matching inquiry log record cannot be retrieved by setting the completion response message to “Matching Inquiry Log Record Cannot Be Retrieved.”

At step 412, consistent with disclosed embodiments, if an inquiry log record that matches or corresponds to the completion request may be retrieved, in some embodiments, completion module(s) 214 may calculate an elapsed time between a matching inquiry log record and a competition request. In some embodiments, the matching inquiry log record will be a previous inquiry response record. Further, in some embodiments, completion module(s) 214 may determine whether the elapsed time exceeds a predetermined timeframe. In some embodiments, the predetermined timeframe may be represented by a real number.

At step 414, consistent with disclosed embodiments, if the determined elapsed time exceeds the predetermined timeframe, in some embodiments, completion module(s) 214 may determine the completion response to indicate that an error has occurred. In some embodiments, completion module(s) 214 may determine the completion response to indicate that the elapsed time exceeds the predetermined timeframe. For example, in some embodiments, the completion response message may indicate that the elapsed time exceeds the predetermined timeframe cannot be retrieved by setting the completion response message to “Elapse Time Exceeds the Predetermined Timeframe.”

Consistent with disclosed embodiments, at step 416, if the determined elapsed time is less than or equal to the predetermined timeframe, in some embodiments, completion module(s) 214 may determine the completion response to indicate that the financial instrument is accepted regardless of the payment guarantee decision. For example, in some embodiments, the completion response message to indicate that the financial instrument is accepted regardless of the payment guarantee decision by setting the completion response message to “Accepted Regardless of Payment Guarantee Decision.”

Consistent with disclosed embodiments, at step 418, completion module(s) 214 may store a plurality of processing information into a database. In some embodiments, the stored plurality of processing information comprises all of the plurality of processing information from step 404. In some embodiments, only a fraction of the plurality of processing information from step 404 is stored. In some embodiments, extracted response(s) and request(s) are stored. Raw response(s) and request(s) are stored, in some embodiments. Further, in some embodiments, the completion response message may be stored.

At step 420, consistent with disclosed embodiments, completion module(s) 214 may build a response having a completion response message. In some embodiments, a competition response the inquiry request may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the inquiry response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 422. At step 422, completion module(s) 214 may send the response to the depository bank via communication network 104.

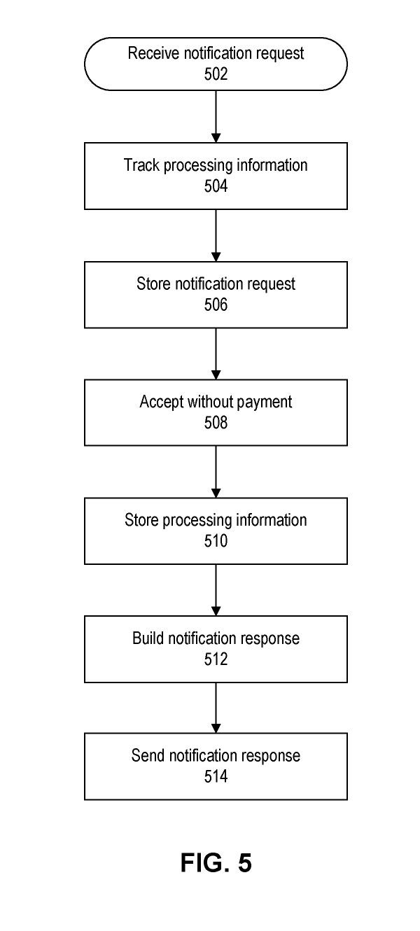

FIG. 5 is a flowchart of an exemplary process for electronically receiving and processing a notification request at a depository bank, consistent with disclosed embodiments. In some embodiments of FIG. 5, a notification request may indicate that a depository bank service 210 wants to provide a message that the depository bank is accepting a financial instrument that is being presented for deposit and a payment guarantee decision is not needed. In some embodiments, customer terminal(s) 101 sends a notification request to notification module(s) 216.

At step 502, consistent with disclosed embodiments, notification module(s) 216 may receive a notification request from a depository bank via communication network 104. In some embodiments, the notification request may contain a financial instrument having a plurality of financial account information. In some embodiments, a notification request has been received from the depository bank 210. In some embodiments, intermediary service 106 may act as an intermediary between depository bank service 210 and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 502.

Consistent with disclosed embodiments, at step 504, notification module(s) 216 may track a plurality of processing information. In some embodiments, notification module(s) 216 may track a plurality of processing information in various ways. For example, in some embodiments, notification module(s) 216 may track the plurality of processing information by printing a plurality of tracking information to a log file. As another example, notification module(s) 214 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 506, consistent with disclosed embodiments, notification module(s) 216 may store a request into database 108. In some embodiments, the request is stored as a notification log record in database 108. In some embodiments, the log record contains other information. For example, the log record may contain a plurality of tracking information, errors, request(s), date(s), other response(s), etc.

Consistent with disclosed embodiments, at step 508, notification module(s) 216 may determine a notification response message to indicate that the financial instrument is accepted without a payment guarantee decision. For example, in some embodiments, the notification response message to indicate that the financial instrument is accepted without a payment guarantee decision by setting the notification response message to “Accepted Without Payment Guarantee Decision.”

Consistent with disclosed embodiments, at step 510, notification module(s) 216 may store a plurality of processing information into a database. In some embodiments, the stored plurality of processing information comprises all of the plurality of processing information from step 504. In some embodiments, only a fraction of the plurality of processing information from step 504 is stored. In some embodiments, extracted response(s) and request(s) are stored. Raw response(s) and request(s) are stored, in some embodiments. Further, in some embodiments, the notification response message may be stored.

At step 512, consistent with disclosed embodiments, notification module(s) 216 may build a response having a notification response message. In some embodiments, a notification response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the notification response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 514. At step 514, notification module(s) 216 may send the response to the depository bank via communication network 104.

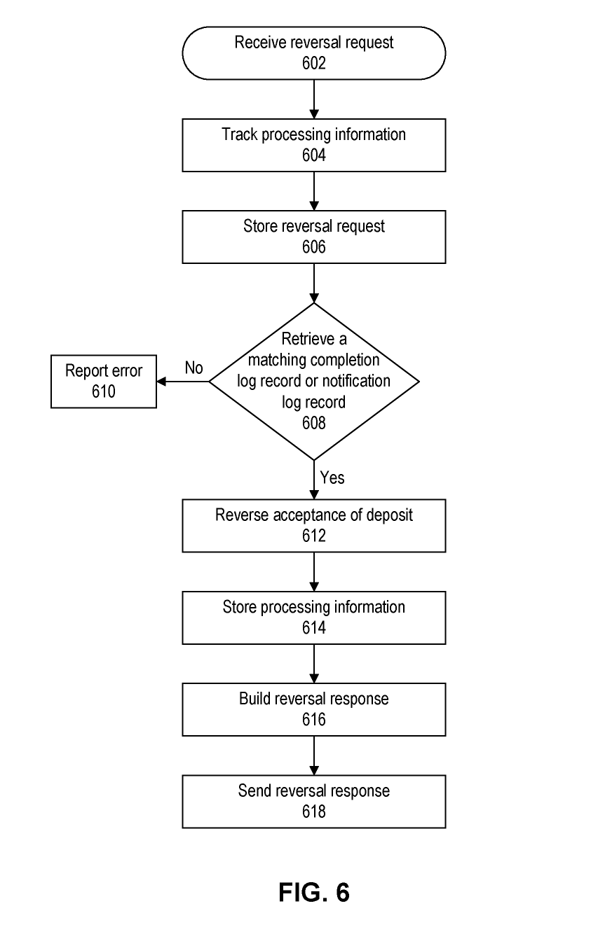

FIG. 6 is a flowchart of an exemplary process for electronically receiving and processing a reversal request at a depository bank, consistent with disclosed embodiments. A reversal request, in some embodiments of FIG. 6, may indicate that depository bank service 210 does not want to accept a deposited financial instrument to which the depository bank previously provided a notification response or acceptance.

At step 602, consistent with disclosed embodiments, reversal module(s) 218 may receive a reversal request from a depository bank via communication network 104. In some embodiments, the reversal request may contain a financial instrument having a plurality of financial account information. In some embodiments, a reversal request has been received from a depository bank 210. In some embodiments, intermediary service 106 may act as an intermediary between depository bank service 210 and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 602. In some embodiments, customer terminal(s) 101 sends a reversal request to reversal module(s) 218.

Consistent with disclosed embodiments, at step 604, reversal module(s) 218 may track a plurality of processing information. In some embodiments, reversal module(s) 218 may track a plurality of processing information in various ways. For example, in some embodiments, reversal module(s) 218 may track the plurality of processing information by printing a plurality of tracking information to a log file. As another example, reversal module(s) 218 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 606, consistent with disclosed embodiments, reversal module(s) 218 may store a request into database 108. In some embodiments, the request is stored as a reversal log record in database 108. In some embodiments, the log record contains other information. For example, the log record may contain a plurality of tracking information, errors, request(s), date(s), other response(s), etc.

At step 608, consistent with disclosed embodiments, reversal module(s) 218 may determine a reversal response message. In some embodiments, reversal module(s) 218 may retrieve a completion log record that matches or corresponds to the reversal request received by step 602. In some embodiments, reversal module(s) 218 may retrieve a notification log record that matches or corresponds to the reversal request received by step 602. In some embodiments, reversal module(s) 218 may search database 108 using key data elements to find a matching completion log and/or record notification log record. As an example, in some embodiments, key data elements used to search database 108 may be one or more of an account number, a date, a timeframe, etc.

At step 610, consistent with disclosed embodiments, if neither a completion log record nor a notification log record that matches or corresponds to the reversal request cannot be retrieved, in some embodiments, reversal module(s) 218 may determine the reversal response to indicate that an error has occurred. In some embodiments, reversal module(s) 218 may determine the reversal response to indicate that the matching record cannot be retrieved. For example, in some embodiments, the reversal response message may indicate that the matching record cannot be retrieved by setting the reversal response message to “Matching Record Cannot Be Retrieved.”

At step 612, consistent with disclosed embodiments, if a completion log record or a notification log record that matches or corresponds to the reversal request may be retrieved, in some embodiments, reversal module(s) 218 may determine the reversal response to indicate that the financial instrument is reversed. For example, in some embodiments, the reversal response message to indicate that the financial instrument is reversed by setting the reversal response message to “Financial Instrument Reversed.”

Consistent with disclosed embodiments, at step 614, reversal module(s) 218 may store a plurality of processing information into a database. In some embodiments, the stored plurality of processing information comprises all of the plurality of processing information from step 604. In some embodiments, only a fraction of the plurality of processing information from step 604 is stored. In some embodiments, extracted response(s) and request(s) are stored. Raw response(s) and request(s) are stored, in some embodiments. Further, in some embodiments, the reversal response message may be stored.

At step 616, consistent with disclosed embodiments, reversal module(s) 218 may build a response having a reversal response message. In some embodiments, a reversal response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the reversal response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 618. At step 618, reversal module(s) 218 may send the response to the depository bank via communication network 104.

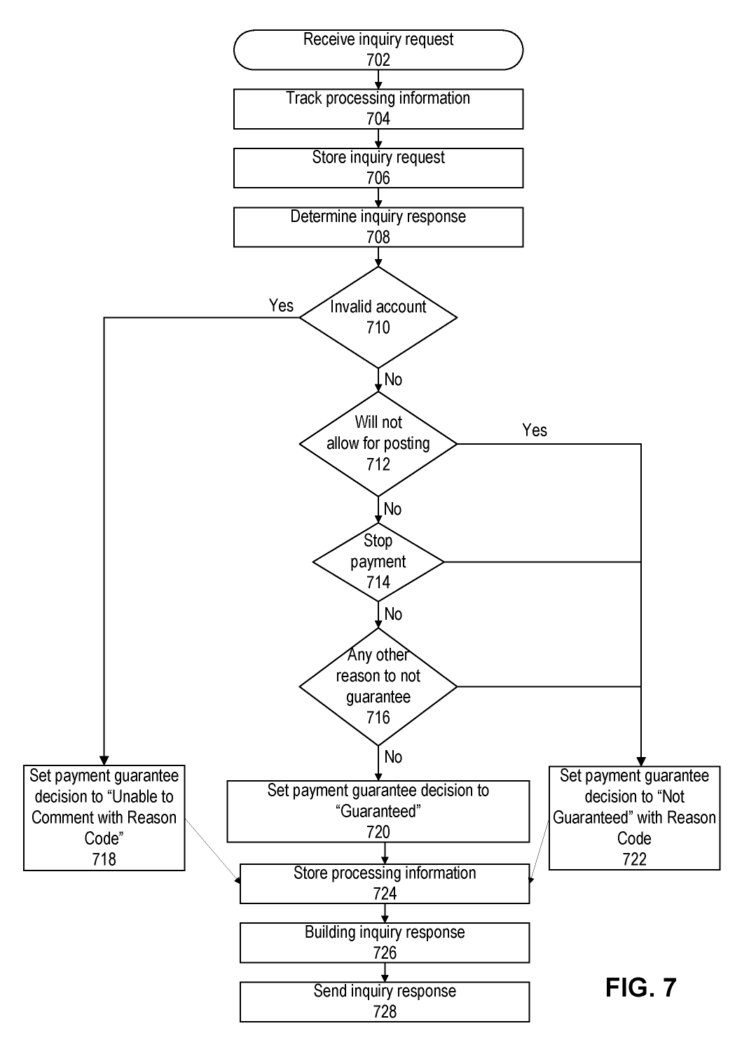

FIG. 7 is a flowchart of an exemplary process for electronically receiving and processing an inquiry request at a paying bank, consistent with disclosed embodiments. In some embodiments of FIG. 7, an inquiry request may indicate that a financial institution wants to find out if a paying bank will guarantee payment of a financial instrument being presented for deposit by a customer at the financial institution. In some embodiments, depository bank service 210 sends an inquiry request to inquiry module(s) 222.

At step 702, consistent with disclosed embodiments, inquiry module(s) 222 may receive an inquiry request from a paying bank via communication network 104. In some embodiments, the inquiry request may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, an inquiry request has been received from a paying bank. In some embodiments, intermediary service 106 may act as an intermediary between a paying bank and other financial institution(s) 107. In some embodiments, the request transmitted is consistent with technology scheme such as XML or XML using XLST of the commercial intermediary service. Further, in some embodiments, the request may be extracted according to the predetermined technology scheme of intermediary service 106, so that data (e.g., financial information) may be used in the succeeding steps. In some embodiments, the extraction of data from the request occurs before step 702.

Consistent with disclosed embodiments, at step 704, inquiry module(s) 222 may track a plurality of processing information. In some embodiments, inquiry module(s) 222 may track a plurality of processing information in various ways. For example, in some embodiments, inquiry module(s) 222 may track the plurality of processing information by printing out tracking information. As another example, inquiry module(s) 222 may track the plurality of processing information using an outside API or commercial product. Further, in some embodiments, the plurality of processing information may include processing information such as changed data, responses at different timeframes, requests at different timeframes, date(s), time(s), event(s), method(s), error(s), etc.

At step 706, consistent with disclosed embodiments, inquiry module(s) 222 may store a request into database 108. In some embodiments, the request is restored as an inquiry log record. At step 708, consistent with disclosed embodiments, inquiry module(s) 222 may determine a payment guarantee decision. In some embodiments, determining a payment guarantee decision may involve running a plurality of payment guarantee rules. In some embodiments, the plurality of guarantee rules calls outside API to determine the payment guarantee decision. In some embodiments, the plurality guarantee rules may use local rules to determine the payment guarantee decision.

Consistent with disclosed embodiments, as an example of the rules, at step 710, inquiry module(s) 222 may use retrieved financial account information to validate whether a financial instrument can be processed. For example, in some embodiments, determining whether a financial instrument can be processed includes determining whether the retrieved financial information associated with the financial instrument is valid. In some embodiments, if the financial information is invalid inquiry module(s) 222 will determine that the financial instrument cannot be processed. As another example, in some embodiments, inquiry module(s) 222 may use the retrieved ABA number and account number from the plurality of financial information in the inquiry request to determine whether the financial account associated with the financial instrument is valid. In some embodiments, if this attempt fails, inquiry module(s) 222 will determine that the financial account is invalid and that the financial instrument cannot be processed. In some embodiments, to determine whether an account is valid, inquiry module(s) 222 may attempt to debit a test amount of money from the account using the ABA number and the account number from the financial information. In some embodiments, if this attempt fails, inquiry module(s) 222 will determine that the financial account is invalid and that the financial instrument cannot be processed. In some embodiments, even if the financial account is valid, inquiry module(s) 222 may determine that the financial instrument cannot be processed due to determining that the account is divested. As a further example, inquiry module(s) 222 may determine that the financial instrument cannot be processed due to the financial instrument being out of scope. As an even further example, inquiry module(s) 222 may determine that the financial instrument cannot be processed due to the financial instrument being an official financial instrument.

As another example, at step 712, consistent with disclosed embodiments, inquiry module(s) 222 may use the retrieved financial account information to confirm that the account will allow for posting. For example, in some embodiments, the retrieved financial account information has a status code (e.g., “Active,” “Closed,” etc.) and/or the status code may indicate if the account is active, closed, etc. In some embodiments, inquiry module(s) 222 may determine that a status code indicating that the account is active will allow for posting, while a status code indicating that the account is closed will not allow for posting. Further, in some embodiments, the retrieved financial account information has a restriction indicator that indicates whether a restriction has been placed on the account. In some embodiments, inquiry module(s) 222 may determine that an account will not allow for posting if the restriction indicator indicates that there is a restriction placed on the account. In some embodiments, if inquiry module(s) 222 determines that an account will not allow for posting, the payment cannot be guaranteed.

At step 714, consistent with disclosed embodiments, as a further example, inquiry module(s) 222 may use the retrieved financial account information to confirm that an instruction to “stop payment” is not associated with the financial instrument. For example, in some embodiments, inquiry module(s) 222 validates whether there is a stop payment on the financial instrument being presented. In some embodiments, inquiry module(s) 222 validates whether there is a stop payment on the account associated with the financial instrument. In some embodiments, if inquiry module(s) 222 determines that a stop payment is associated with a financial instrument, the payment cannot be guaranteed.

Consistent with disclosed embodiments, at step 716, various other reasons for not guaranteeing the deposit may be determined. For example, in some embodiments, inquiry module(s) 222 may retrieve information concerning the deposit account from the plurality of account information. In some embodiments, the plurality of account information contains a date that the deposit account was open. In some of these embodiments, inquiry module(s) 222 may check that the deposit account has been open longer than a predetermined period of time (e.g., one year). In some embodiments, if inquiry module(s) 222 determines that the deposit account has not been open longer than a predetermined period, the payment cannot be guaranteed.

Moreover, in some embodiments, inquiry module(s) 222 may evaluate whether a financial instrument is lost, stolen, or counterfeit. Inquiry module(s) 222 can use a variety of ways to determine whether a financial instrument is lost, stolen, or counterfeit. For example, in some embodiments, inquiry module(s) 222 call outside API(s) to determine whether a financial instrument is lost or stolen. In some embodiments, this determination is internal. As another example, in some embodiments, inquiry module(s) 222 may evaluate whether the financial instrument is lost or stolen by checking a database. In some embodiments, if inquiry module(s) 222 determines that a financial instrument is lost, stolen, or counterfeit, the payment cannot be guaranteed.

Further, in some embodiments, the plurality of account information contains a plurality of information useful in calculating funds availability score(s). In some of these embodiments, inquiry module(s) 222 calculates the proprietary funds availability score(s) to determine that an account is not “high risk.” In some of these embodiments, one or more funds availability score(s) are weighted to determine that the account is not “high risk.” In some of these embodiments, if an account is scored as high risk, the payment cannot be guaranteed.

Additionally, in some embodiments, the plurality of information contains the account balance of the deposit account. In some embodiments, inquiry module(s) 222 may check to see if the amount of the presented financial instrument does not exceed a predetermined percentage of the account balance of the deposit account that is available for withdrawal. For example, inquiry module(s) 222 may determine that a predetermined percentage of the account balance of the deposit account is 50% and, therefore, the amount of the presented financial instrument would have to be over $50 with the account balance of the deposit account being $100. Using this example, inquiry module(s) 222 would determine that a financial instrument with an amount greater than $50 would not be guaranteed for payment. In some embodiments, inquiry module(s) 222 may determine that, if a balance is insufficient to honor an item, the payment cannot be guaranteed. The above examples do not limit the other various ways that would be obvious to one of ordinary skill in the art may use to determine a payment guarantee decision. Further, the above examples and others may be performed in any other combination or order.

Consistent with disclosed embodiments, at step 718, if at least one of the processing rules cannot retrieve a predetermined number of required account information or data, inquiry module(s) 222 may determine a payment guarantee decision to indicate that the financial instrument was not able to be processed. In some embodiments, if the financial account is invalid according to step 710, inquiry module(s) 222 may determine a payment guarantee decision to indicate that the financial instrument was not able to be processed. For example, in some embodiments, the inquiry response message to indicate that the financial instrument is accepted without a payment guarantee decision by setting the inquiry response message to “Unable to Comment with Reason.” In some embodiments, a processing rule produces a reason code when a predetermined number of required plurality of account information or data cannot be retrieved. In some embodiments, inquiry module(s) 222 may determine a payment guarantee decision to indicate that the financial instrument was not able to be processed with the reason code. For example, in some embodiments, the inquiry response message to indicate that the financial instrument is accepted without a payment guarantee decision by setting the inquiry response message to “‘Unable to Comment’ with Reason with the reason code.”

At step 720, consistent with disclosed embodiments, if a predetermined amount of the plurality of payment guarantee rules satisfies that a payment guarantee should be guaranteed, inquiry module(s) 222 may determine a payment guarantee decision to indicate that the financial instrument is guaranteed. For example, in some embodiments, the inquiry response message to indicate that the financial instrument is accepted without a payment guarantee decision by setting the inquiry response message to “Guaranteed.”

At step 722, consistent with disclosed embodiments, if a predetermined amount of the plurality of payment guarantee rules does not satisfy that a payment guarantee should be guaranteed, inquiry module(s) 222 may determine a payment guarantee decision to indicate that the financial instrument is not guaranteed. For example, in some embodiments, inquiry module(s) 222 may determine a payment guarantee decision to indicate that the financial instrument is not guaranteed by setting the inquiry response message to “Not Guaranteed.” In some embodiments, a processing rule produces a reason code when the processing rule cannot guarantee payment. In some embodiments, inquiry module(s) 222 may determine a payment guarantee decision by indicating that the financial instrument is not guaranteed with the reason code. For example, in some embodiments, inquiry module(s) 222 may determine a payment guarantee decision to indicate that the financial instrument is not guaranteed by setting the inquiry response message to “Not Guaranteed with Reason with the reason code.”

Consistent with disclosed embodiments, at step 724, inquiry module(s) 222 may store a plurality of processing information into a database. In some embodiments, the stored plurality of processing information comprises all of the plurality of processing information from step 704. In some embodiments, only a fraction of the plurality of processing information is stored. Extracted response(s) and request(s) stored in some embodiments. In some embodiments, raw response(s) and request(s) are stored. Further, in some embodiments, the payment guarantee received from a paying bank is stored.

At step 726, consistent with disclosed embodiments, inquiry module(s) 222 may build a response having a guarantee decision. In some embodiments, the inquiry response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the inquiry response may be built according to a predetermined technology schedule of intermediary service 106. In some embodiments, the response transmitted is consistent with a predetermined technology scheme using technology such as XML or XML using XLST of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 728. At step 728, inquiry module(s) 222 may send the response to a paying bank via communication network 104.

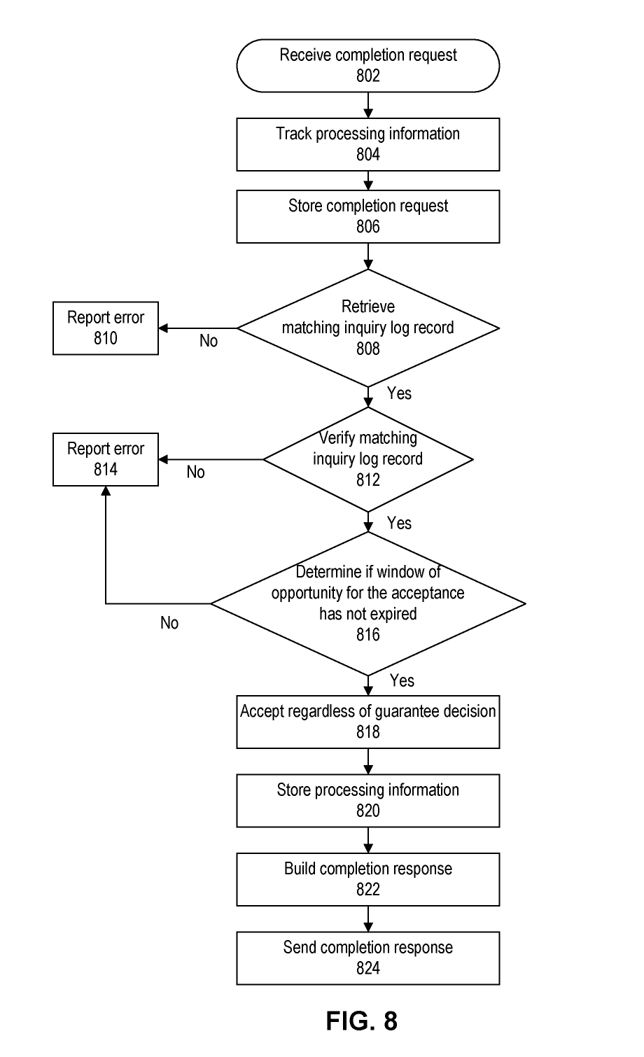

FIG. 8 is a flowchart of an exemplary process for electronically receiving and processing a completion request at a paying bank, consistent with disclosed embodiments. A completion request, in some embodiments of FIG. 8, may indicate that a financial institution wants to confirm that the paying bank is paying a financial instrument being presented for deposit based on the payment guarantee decision returned in a previous response to an inquiry response. In some embodiments, the paying bank may want to provide a message that the paying bank is accepting a financial instrument being presented for deposit despite the payment guarantee decision returned in a previous response to an inquiry response after receiving a completion request. In some embodiments, depository bank service 210 sends a completion request to completion module(s) 224.

At step 802, consistent with disclosed embodiments, completion module(s) 224 may receive a completion request from a depository bank via communication network 104. In some embodiments, the completion request may contain a financial instrument having a plurality of financial account information. In some embodiments, a completion request has been received from depository bank service 210. In some embodiments, intermediary service 106 may act as an intermediary between depository bank service 210 and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 802.

Consistent with disclosed embodiments, at step 804, completion module(s) 224 may track a plurality of processing information. In some embodiments, completion module(s) 224 may track a plurality of processing information in various ways. For example, in some embodiments, completion module(s) 224 may track the plurality of processing information by printing a plurality of tracking information to a log file. As another example, completion module(s) 224 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 806, consistent with disclosed embodiments, completion module(s) 224 may store a request into database 108. In some embodiments, the request is stored as a completion log record in database 108. In some embodiments, the log record contains other information. For example, the log record may contain a plurality of tracking information, errors, request(s), date(s), other response(s), etc.

At step 808, consistent with disclosed embodiments, completion module(s) 224 may determine a completion response message. In some embodiments, completion module(s) 224 may retrieve an inquiry log record that matches or corresponds to the completion request received by step 401. In some embodiments, completion module(s) 214 may search database 108 using key data elements to find a matching inquiry log record. As an example, in some embodiments, key data elements used to search database 108 may be one or more of an account number, a date, a timeframe, etc.

At step 810, consistent with disclosed embodiments, if an inquiry log record that matches or corresponds to the completion request cannot be retrieved, in some embodiments, completion module(s) 224 may determine the completion response to indicate that an error has occurred. In some embodiments, completion module(s) 224 may determine the completion response to indicate that the matching inquiry log record cannot be retrieved. For example, in some embodiments, the completion response message may indicate that the matching inquiry log record cannot be retrieved by setting the completion response message to “Matching Inquiry Log Record Cannot Be Retrieved.”

At step 812, consistent with disclosed embodiments, if an inquiry log record that matches or corresponds to the completion request may be retrieved, in some embodiments, completion module(s) 214 verify that a plurality of key data elements from the matched inquiry log record matches exactly with data elements in the completion request. In some embodiments, if the plurality of key data elements from the matched inquiry log record matches exactly with data elements in the completion request, then completion module(s) 214 verifies that a predetermined window of opportunity for the acceptance of the guarantee has not expired.

At step 814, consistent with disclosed embodiments, if the plurality of key data elements from the matched inquiry log record does not match exactly with data elements in the completion request, in some embodiments, completion module(s) 224 may determine the completion response to indicate that an error has occurred. In some embodiments, completion module(s) 224 may determine the completion response to indicate that the plurality of key data elements from the matched inquiry log record does not match exactly with data elements in the completion request. For example, in some embodiments, the completion response message may indicate that the plurality of key data elements from the matched inquiry log record does not match exactly with data elements in the completion request by setting the completion response message to “No Matching Inquiry Log Record Found.”

Consistent with disclosed embodiments, at step 816, if the predetermined window of opportunity for the acceptance of the guarantee has expired, in some embodiments completion module(s) 224 may determine the completion response to indicate that an error has occurred. In some embodiments, completion module(s) 224 may determine that the predetermined window of opportunity for the acceptance of the guarantee has expired. For example, in some embodiments, the completion response message may indicate that the predetermined window of opportunity for the acceptance of the guarantee has expired by setting the completion response message to “Window of Opportunity for Acceptance of the Guarantee has expired.”

Consistent with disclosed embodiments, at step 818, if the plurality of key data elements from the matched inquiry log record does match exactly with data elements in the completion request and the predetermined window of opportunity for the acceptance of the guarantee has not expired, in some embodiments, completion module(s) 224 may determine the completion response to indicate that the financial instrument is accepted, regardless of the payment guarantee decision. For example, in some embodiments, the completion response message may indicate that the financial instrument is accepted, regardless of the payment guarantee decision, by setting the completion response message to “Accepted Regardless of Payment Guarantee Decision.”

Consistent with disclosed embodiments, at step 820, completion module(s) 224 may store a plurality of processing information into a database. In some embodiments, the stored plurality of processing information comprises all of the plurality of processing information from step 804. In some embodiments, only a fraction of the plurality of processing information from step 804 is stored. In some embodiments, extracted response(s) and request(s) are stored. Raw response(s) and request(s) are stored, in some embodiments. Further, in some embodiments, the completion response message may be stored.

At step 822, consistent with disclosed embodiments, completion module(s) 224 may build a response having a completion response message. In some embodiments, a competition response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the inquiry response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 824. At step 824, completion module(s) 224 may send the response to depository bank service 210 via communication network 104.

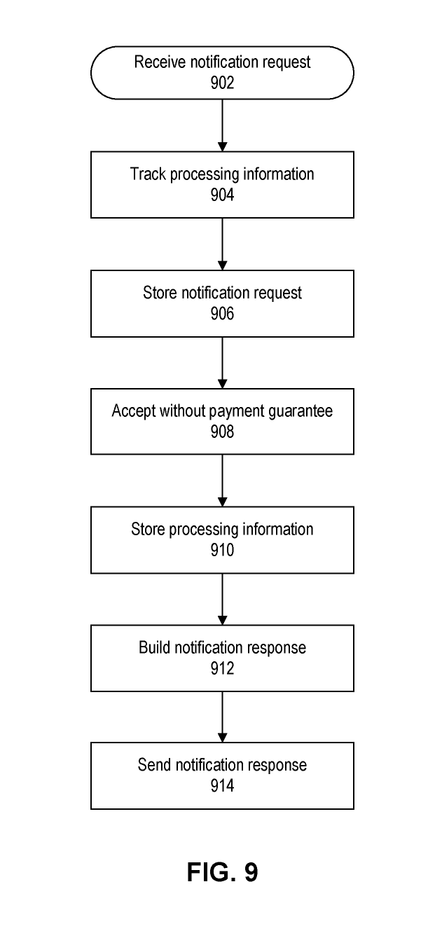

FIG. 9 is a flowchart of an exemplary process for electronically receiving and processing a notification request at a paying bank, consistent with disclosed embodiments. In some embodiments of FIG. 9, a notification request may indicate that a paying bank wants to provide a message that the paying bank is paying bank a financial instrument that is being presented for deposit and a payment guarantee decision is not needed. In some embodiments, depository bank service 210 sends a notification request to notification module(s) 226.

At step 902, consistent with disclosed embodiments, notification module(s) 226 may receive a notification request from another financial institution via communication network 104. In some embodiments, the notification request may contain a financial instrument having a plurality of financial account information. In some embodiments, a notification request has been received from another financial institution. In some embodiments, intermediary service 106 may act as an intermediary between a paying bank and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 902.

Consistent with disclosed embodiments, at step 904, notification module(s) 226 may track a plurality of processing information. In some embodiments, notification module(s) 226 may track a plurality of processing information in various ways. For example, in some embodiments, notification module(s) 226 may track the plurality of processing information by printing a plurality of tracking information to a log file. As another example, notification module(s) 214 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 906, consistent with disclosed embodiments, notification module(s) 226 may store a request into database 108. In some embodiments, the request is stored as a notification log record in database 108. In some embodiments, the log record contains other information. For example, the log record may contain a plurality of tracking information, errors, request(s), date(s), other response(s), etc.

Consistent with disclosed embodiments, at step 908, notification module(s) 226 may determine a notification response message to indicate that the financial instrument is accepted without a payment guarantee decision. For example, in some embodiments, the notification response message may indicate that the financial instrument is accepted without a payment guarantee decision by setting the notification response message to “Accepted Without Payment Guarantee Decision.”

Consistent with disclosed embodiments, at step 910, notification module(s) 226 may store a plurality of processing information into a database. In some embodiments, the stored plurality of processing information comprises all of the plurality of processing information from step 904. In some embodiments, only a fraction of the plurality of processing information from step 904 is stored. In some embodiments, extracted response(s) and request(s) are stored. Raw response(s) and request(s) are stored, in some embodiments. Further, in some embodiments, the notification response message may be stored.

At step 912, consistent with disclosed embodiments, notification module(s) 226 may build a response having a notification response message. In some embodiments, a notification response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the notification response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 914. At step 914, notification module(s) 226 may send the response to depository bank 210 via communication network 104.

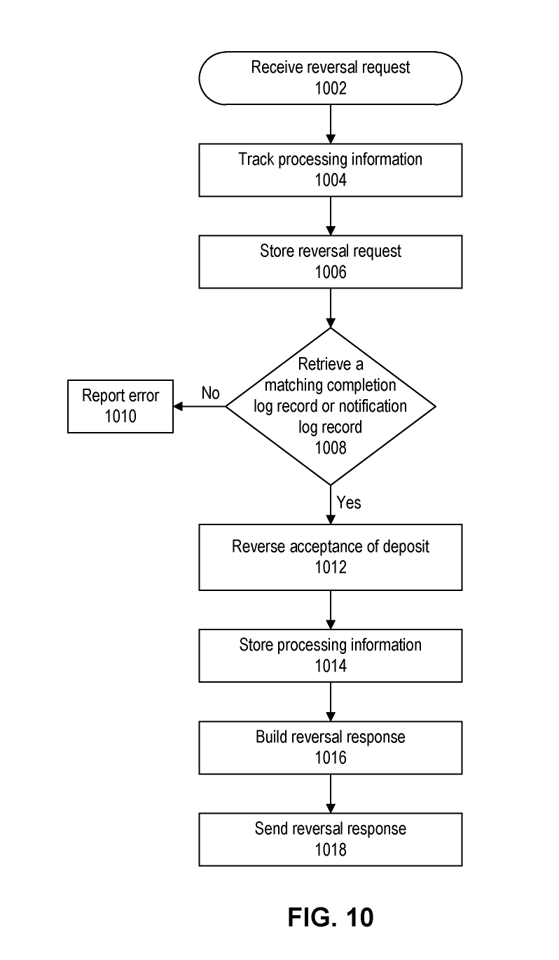

FIG. 10 is a flowchart of an exemplary process for electronically receiving and processing a reversal request at a paying bank, consistent with disclosed embodiments. In some embodiments, a reversal request may indicate that a paying bank does not want to pay financial instrument to which the paying bank previously provided a notification response or completion response indicating acceptance. In some embodiments, depository bank service 210 sends a reversal request to reversal module(s) 228.

At step 1002, consistent with disclosed embodiments, reversal module(s) 228 may receive a reversal request from a paying bank via communication network 104. In some embodiments, the reversal request may contain a financial instrument having a plurality of financial account information. In some embodiments, a reversal request has been received from a paying bank. In some embodiments, intermediary service 106 may act as an intermediary between a paying bank and other financial institution(s) 107. In some embodiments, the request transmitted is consistent with a predetermined technology scheme such as XML or XML using XSLT of the commercial intermediary service. Further, in some embodiments, the request may be extracted according to the predetermined technology scheme of intermediary service 106, so that data (e.g., financial information) may be used in the succeeding steps. In some embodiments, the extraction of data from the request happens before step 1002.

Consistent with disclosed embodiments, at step 1004, reversal module(s) 228 may track a plurality of processing information. In some embodiments, reversal module(s) 228 may track a plurality of processing information in various ways. For example, in some embodiments, reversal module(s) 228 may track the plurality of processing information by printing a plurality of tracking information to a log file. As another example, reversal module(s) 228 may track the plurality of processing information using an outside API of a commercial product. Further, in some embodiments, the plurality of processing information may include processing information such as changed data, responses at different timeframes, requests at different timeframes, date(s), time(s), event(s), method(s), error(s), etc.

At step 1006, consistent with disclosed embodiments, reversal module(s) 228 may store a request into database 108. In some embodiments, the request is stored as a reversal log record in database 108. In some embodiments, the log record contains other information. For example, the log record may contain a plurality of tracking information, errors, request(s), date(s), other response(s), etc.

At step 1008, consistent with disclosed embodiments, reversal module(s) 226 may determine a reversal response message. In some embodiments, reversal module(s) 226 may retrieve a completion log record that matches or corresponds to the reversal request received by step 1002. In some embodiments, reversal module(s) 226 may retrieve a notification log record that matches or corresponds to the reversal request received by step 1002. In some embodiments, reversal module(s) 218 may search database 108 using key data elements to find a matching notification log record and/or completion log record. As an example, in some embodiments, key data elements used to search database 108 may be one or more of an account number, a date, a timeframe, etc.

At step 1010, consistent with disclosed embodiments, if a notification log record or competition log record that matches or corresponds to the reversal request cannot be retrieved, in some embodiments, reversal module(s) 226 may determine the reversal response to indicate that an error has occurred. In some embodiments reversal module(s) 226 may determine the reversal response to indicate that the matching record cannot be retrieved. For example, in some embodiments, the reversal response message may indicate that the matching record cannot be retrieved by setting the reversal response message to “Matching Record Cannot Be Retrieved.”

Consistent with disclosed embodiments, at step 1012, if an inquiry log record that matches or corresponds to the reversal request may be retrieved, in some embodiments, reversal module(s) 226 may determine the reversal response to indicate that the financial instrument is reversed. For example, in some embodiments, the reversal response message to indicate that the financial instrument is reversed by setting the reversal response message to “Financial Instrument Reversed.”

Consistent with disclosed embodiments, at step 1014, reversal module(s) 228 may store a plurality of processing information into a database. In some embodiments, the stored plurality of processing information comprises all of the plurality of processing information from step 1004. In some embodiments, only a fraction of the plurality of processing information from step 1004 is stored. In some embodiments, extracted response(s) and request(s) are stored. Raw response(s) and request(s) are stored, in some embodiments. Further, in some embodiments, the reversal response message may be stored.

At step 1016, consistent with disclosed embodiments, reversal module(s) 228 may build a response having a reversal response message. In some embodiments, a reversal response may contain information associated with a financial instrument, such as a transit number and/or an American Banking Association (ABA) routing number, an account number, a date of the transaction, a date of payment, a name of the payee, the name of the payer, memoranda associated with the financial instrument, an image of the signature associated with the financial instrument, a number associated with the financial instrument, an image of the financial instrument, or the like. In some embodiments, the reversal response may be built according to a predetermined technology schedule of intermediary service 106. In some embodiments, the response transmitted is consistent with a predetermined technology scheme using technology such as XML or XML using XSLT of a commercial intermediary service. Further, in some embodiments, the response may be constructed according to the predetermined technology scheme of intermediary service 106, so that data (e.g., financial information) may be used in the succeeding steps. In some embodiments, the response may be constructed after step 1018. At step 1018, reversal module(s) 228 may send the response to a depository bank via communication network 104.

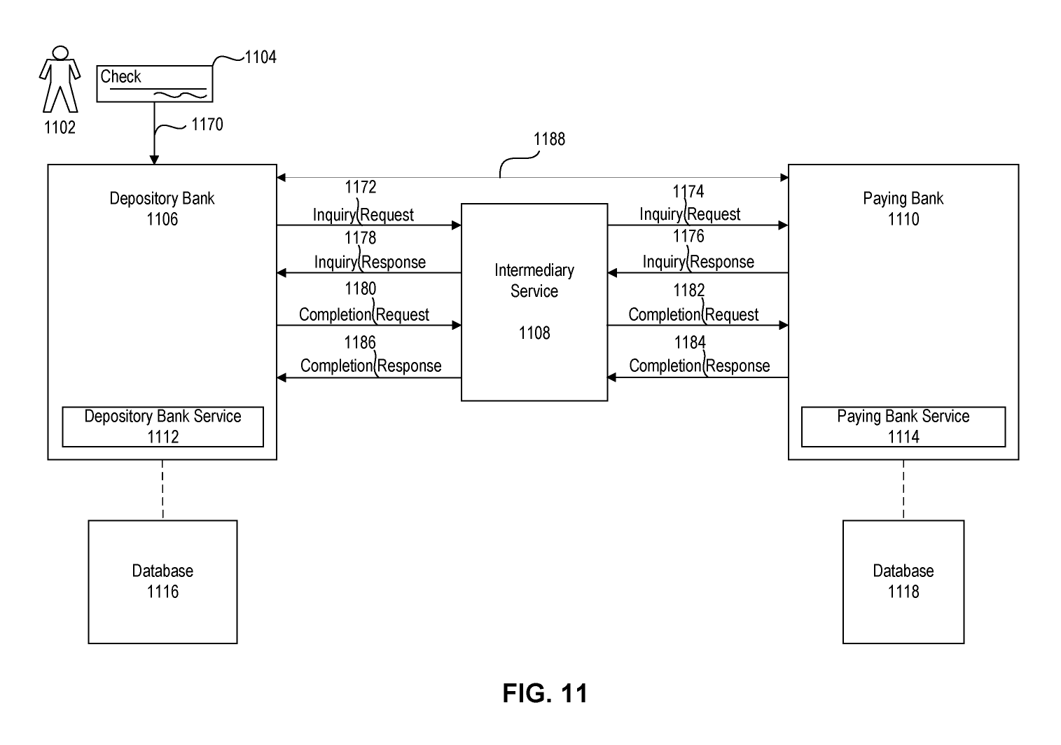

FIG. 11 is an illustrative example of processing a financial instrument using orchestration layer, consistent with disclosed embodiments. In some embodiments, the steps described with respect to FIG. 11 occur in real time and/or serially.

Consistent with disclosed embodiments, at step 1170, a customer 1102 goes to depository bank 1106 to deposit a financial instrument, here, check 1104. In some embodiments, account information on check 1104 associates the customer check with a financial account at paying bank 1110. After receiving the check 1104, depository bank 1106 extracts a plurality of financial information from the check 1104. For simplicity and illustrative purposes only, both depository bank 1106 and paying bank 1110 have the infrastructure described by FIG. 1.

At step 1172, consistent with disclosed embodiments, depository bank 1106 uses depository bank service 1112 to receive an inquiry request. The depository bank may receive check 1104 through a customer channel (not shown). Depository bank 1106 processes the request according to FIG. 3. In some embodiments, the inquiry request is generated by depository bank 1106 during the extraction of the plurality of financial information in step 1170. In some embodiments, the inquiry request is produced later by depository bank 1106 or by another financial institution (not shown). Further, for illustrative purposes only, in step 1172, depository bank service 1112 needs to acquire a payment guarantee in step 312 from paying bank 1110. To acquire from paying bank 1110, depository bank 1106 sends an inquiry request to paying bank 1110 via intermediary service 1108. It should be appreciated that the inquiry response may conform to a predetermined technology scheme that intermediary service 1108 requires.

At step 1174, consistent with disclosed embodiments, paying bank 1110 uses paying bank service 1114 to receive the inquiry request from step 1172. Paying bank service 1114 processes the inquiry request in accordance with FIG. 7.

Consistent with disclosed embodiments, at step 1176, and consistent with the steps of FIG. 7, paying bank 1105 sends an inquiry response to the inquiry request from step 1172 to depository bank 1106 via intermediary service 1108. It should be appreciated that the inquiry response may conform to a predetermined technology scheme that intermediary service 1108 requires.

At 1178, consistent with disclosed embodiments, depository bank service 1112 at depository bank 1106 receives the inquiry response and completes the steps of FIG. 3 in step 1172. In some embodiments, depository bank 1106 may generate a response to receiving the inquiry response.

Consistent with disclosed embodiments, at 1180, in response to receiving the inquiry response in step 1178, depository bank may generate a completion request and send the completion request to paying bank 1110 via intermediary service 1108. It should be appreciated that the inquiry response may conform to a predetermined technology scheme that intermediary service 1108 requires.

At step 1182, consistent with disclosed embodiments, paying bank 1110 uses paying bank service 1114 to receive the completion request from step 1180. Paying bank service 1114 processes the completion request in accordance with step FIG. 8.

Consistent with disclosed embodiments, at step 1184, and consistent with the steps of FIG. 8, paying bank 1110 sends a completion response to completion request from step 1182 to depository bank 1106 via intermediary service 1108. It should be appreciated that the inquiry response may conform to a predetermined technology scheme that intermediary service 1108 requires.

Consistent with disclosed embodiments, at step 1186, depository bank service 1112 at depository bank 1106 receives the completion response. In some embodiments, depository bank service 1112 causes one or more of customer terminal(s) 101 to display in real time that the financial instrument is deposited into the customer's financial account. In some embodiments, depository bank service 1112 causes one of customer terminal(s) 101 to display that the deposit amount of the financial instrument is available (not shown). In some embodiments, depository bank service 1112 causes one or more of analytic application(s) 111 on one or more analyzer terminal(s) 112 to update and display in real time a plurality of analytical information concerning various account to include the newly deposited financial instrument. In some these embodiments, the real-time display may be implemented by means of Asynchronous JavaScript (AJAX), Ruby™, and/or database 108. However, various other methods to implement real-time updating and displaying information to terminals or end-point devices may be used.

Consistent with disclosed embodiments, at step 1188, depository bank 1106 and paying bank 1110 may further verify the above transaction through a batch exchange of Image Cash Letter (ICL) files between the banks. In some embodiments, this further verification may be done using physical or paper financial instruments. In some embodiments, this verification does not prevent depository bank 1106 from immediately receiving a payment guarantee decision electronically over a network from paying bank 1110 before guaranteeing the availability of funds to the customer. In some embodiments, this verification does not prevent any module of depository bank service 1112 or paying bank service 1114 from executing and/or completing before this verification initiated and/or completed.

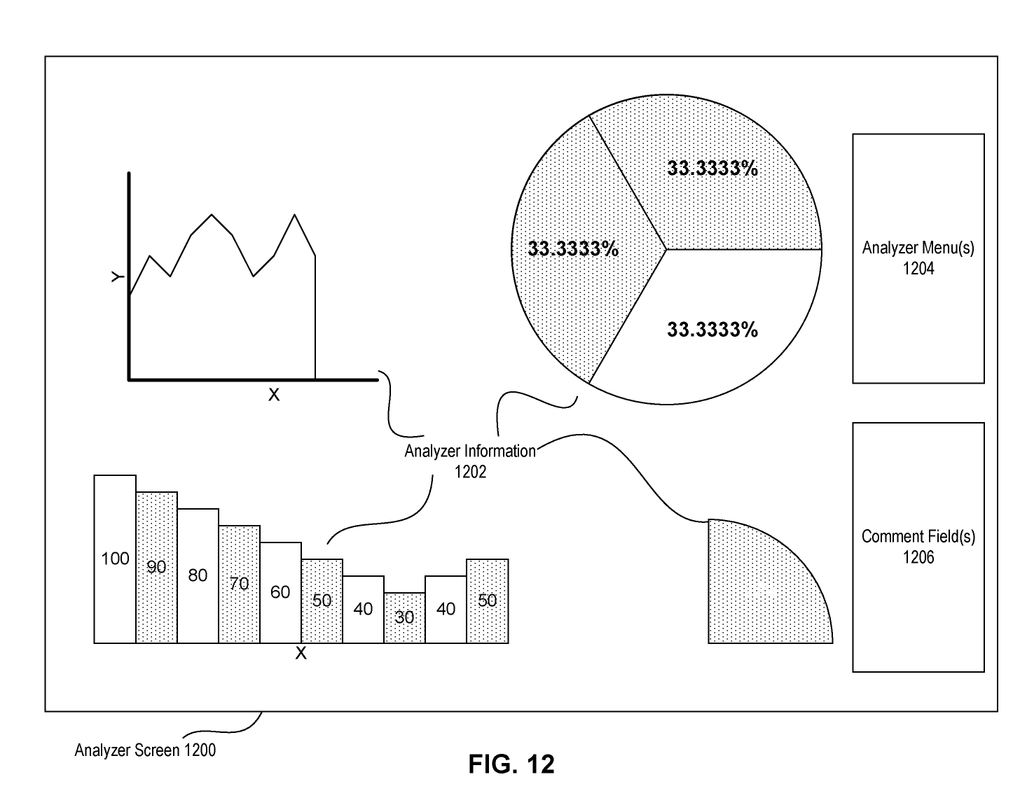

FIG. 12 is a diagram of an exemplary screen that may be presented on a terminal, consistent with disclosed embodiments. Analyzer screen 1200, consistent with disclosed embodiments, may be presented on a device such as analyzer terminal(s) 112 via an application such as analytic application(s) 111. Analytic application(s) 111 may configure the layout of analyzer screen 1200, using programming platforms such as JQuery™, NodeJs™, JavaScript™, Twitter Bootstrap™, XAML, or the like. In some embodiments, analytic application(s) 111 can cause analyzer screen 1200 to update using these programming platforms or the like.

Consistent with disclosed embodiments, analyzer information 1202 may be displayed to an analyzer using one or more analyzer terminal(s) 112. In some embodiment, an analyzer is an employee of a bank. In some embodiments, an analyzer may be an automated device, computer, or some other software or interactive technology. In some embodiments, analytic application(s) 111 can cause analyzer information 1202 to update using programming platforms such as JQuery™, NodeJs™, JavaScript™, Twitter Bootstrap™, XAML, or the like. In some embodiments, analytic application(s) 111 retrieves analyzer information 1202 from database(s) 108 and displays it on analyzer terminal(s) 112 using a commercial product, such as Tableau™. In some embodiments, analytic application(s) 111 retrieves analyzer information 1202 from database(s) 108 and displays it on analyzer terminal(s) 112 using instructions stored on analyzer terminal(s) 112. In some embodiments, analytic application(s) 111 retrieves analyzer information 1202 from database(s) 108 and displays it on analyzer terminal(s) 112 using instructions stored externally. Analyzer information 1202 may be displayed in any way that statistics can be visually displayed, such as in graph(s), chart(s), line(s), text, number(s), etc. The display of analyzer information 1202 is not limited to those in FIG. 12. In some embodiments, analyzer screen 1200 may contain a plurality of analyzer information 1202, and, therefore, the display of analyzer information 1202 is not limited in number to that in FIG. 12.

In some embodiments, analyzer information 1202 is predictive and projects different useful insights from stored data in database(s) 108. In some embodiments, analyzer information 1202 consists of the raw data stored in database(s) 108. In some embodiments, analyzer information 1202 may display information in a variety of ways. For example, in some embodiments, analyzer information 1202 may comprise information such as the average response time and response time distribution a type of request or response (i.e., Inquiry, Completion, Notification, Reversal, or the like) for one or more of a depository bank and a paying bank. As another example, in some embodiments, analyzer information 1202 may comprise information such as the total population, amount of money processed, the number of payments accepted with guarantee, the number of payments accepted without guarantee, or any combination thereof, or the like, for one or more of a depository bank and a paying bank. Many other examples of analyzer information 1202 that derive wholly or partially from raw data stored in database(s) 108 and information processed by orchestration layer 105 may also be displayed. Therefore, the above examples are not exhaustive.

Analyzer menu(s) 1204, consistent with disclosed embodiments, can be manipulated to cause analyzer information 1202 to be displayed on analyzer terminal(s) 112. In some embodiments, when an analyzer manipulates a field on analyzer menu(s) 1204, analyzer information 1202 is displayed differently on analyzer terminal(s) 112. In some embodiments, analytic menu(s) 1204 can cause analyzer application(s) 111 to update one or more of a plurality of analyzer information 1202 using programming platforms such as JQuery™, NodeJs™, JavaScript™, Twitter Bootstrap™, XAML, or the like. In some embodiments, when an analyzer manipulates a field on analyzer menu(s) 1204, analyzer information 1202 is displayed differently in an autonomous way on analyzer terminal(s). In some embodiments, analyzer menu(s) 1204 may contain one or more fields denoting categories of information (e.g., transaction date(s), depository bank(s), paying bank(s), deposit channel(s), deposit amount(s), response time(s), etc.) to which an analyzer wants the displayed analyzer information 1202 to conform. These fields denoting contain one or more fields denoting categories of information may be displayed differently and in a multitude of ways.

Analyzer comment field(s) 1206, consistent with disclosed embodiments, may allow an analyzer to leave comments related to particular analyzer information 1202. In some embodiments, comments can be seen by other analyzers. In some embodiments, comments are private. In some embodiments, analyzer comment field(s) may allow multiple analyzers to communicate with each other in real time. In some embodiments, analyzer comment field(s) 1206 may not associate comments to particular analyzer information 1202. As an example, analyzer comment field(s) may comprise general message board, texting platform, messaging service, or the like. In some embodiments, analyzer comments can cause analyzer application(s) 111 to update analyzer information 1202 to display on analyzer terminal(s) 112 differently. For example, in some embodiments, an analyzer may use a special token to delineate a command to cause analyzer application(s) 111 to update analyzer information 1202 to display on analyzer terminal(s) 112 differently. In some embodiments, an analyzer may use a special token to delineate a command to cause analyzer application(s) 111 to update analyzer information 1202 to display differently on the analyzer terminal(s) 112 of one or more other analyzers. As one example, the special token may be denoted as “@command,” and, therefore, an analyzer inputting “update timeline to a year” into the comment field may serve as a comment to another analyzer while an analyzer inputting “@command update timeline to a year” into the comment field may serve as a command that causes to update analyzer information 1202 to display differently on the analyzer terminal(s) 112 of one or more other analyzers or the same analyzer. In some embodiments, an analyzer can target, specifically, at least one analyzer terminal 112. A multitude of other examples or implementations exists for updating analyzer information 1202 via comment field(s) 1206, and any combination thereof to achieve the result can be used.

Descriptions of the disclosed embodiments are not exhaustive and are not limited to the precise forms or embodiments disclosed. Modifications and adaptations of the embodiments will be apparent from consideration of the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

1-18. (canceled)

19. A system for electronically processing a real-time payment at a depository bank, the system comprising:
a memory storing instructions; and
one or more processors configured to execute the instructions to:
serially send, to one or more financial institutions via an intermediary service, a plurality of inquiry requests, wherein each inquiry request comprises a financial instrument that is being presented for deposit at a depository bank and is built according to a predetermined structure required by the intermediary service;
serially receive, from the one or more financial institutions via the intermediary service, a plurality of inquiry responses,
wherein each inquiry response is received in real time in response to one respective inquiry request being sent, and
wherein each inquiry response comprises a payment guarantee decision, the payment guarantee decision specifying whether the payment for the financial instrument is or is not guaranteed;
serially build a plurality of completion requests according to the predetermined structure required by the intermediary service;
serially send, to the one or more financial institutions via the intermediary service, the plurality of completion requests, wherein each completion request is sent in real time in response to one of the plurality of inquiry responses being received;
serially receive, from the one or more financial institutions via the intermediary service, a plurality of completion responses, wherein each completion response is received in real time in response to one of the plurality of completion requests being sent; and
serially post the plurality of financial instruments of the plurality of inquiry responses for the deposit into one or more financial accounts, wherein each financial instrument is posted based on at least one of the plurality of the payment guarantee decisions and one of the plurality of completion responses.

20. The system of claim 19, wherein the one or more processors are further configured to execute instructions to:
determine whether a first financial instrument of the plurality of financial instruments has a deposit amount that is greater than or equal to a threshold amount; and
if the deposit amount is greater or equal to the threshold amount:
acquire the payment guarantee decision for the first financial instrument from the one or more financial institutions.

21. The system of claim 19, wherein the one or more processors are further configured to execute instructions to:
determine whether a first financial instrument of the plurality of financial instruments has a deposit amount that is greater than or equal to a threshold amount; and
if the deposit amount is less than the threshold amount:
post the first financial instrument for the deposit into the one or more financial accounts without requiring the payment guarantee decision.

22. The system of claim 19, wherein the one or more processors are further configured to execute instructions to:
send a reversal request to reverse the posting of a first financial instrument of the plurality of financial instruments for the deposit;
receive a reversal response from the one or more financial institutions; and
reverse the posting of the first financial instrument for deposit.

23. The system of claim 19, wherein the one or more processors are further configured to execute instructions to:
send a notification request to the one or more financial institutions;
receive a notification response from the one or more financial institutions; and
post a first financial instrument of the plurality of financial instruments for the deposit into one or more financial accounts regardless of one of the plurality of payment guarantee decisions.

24. The system of claim 19, wherein the one or more processors are further configured to execute instructions to verify the posting of a first financial instrument of the plurality of financial instruments by exchanging an image cash letter file with the financial institution.

25. The system of claim 19, wherein the one or more processors are further configured to execute instructions to update in real-time the posting of a first financial instrument of the plurality of financial instruments in a deposit platform that is available to the customer of the financial account.

26. The system of claim 19, wherein each of the financial instruments comprises a banking account number and a routing number.

27. The system of claim 19, wherein the one or more processors are further configured to execute instructions to cash a first financial instrument of the plurality of financial instruments for the deposit into the one or more financial accounts based on one of the plurality of payment guarantee decision and one of the plurality of completion request.

28. (canceled)

29. The system of claim 19, wherein the intermediary service is a commercial intermediary service.

30. (canceled)

31. The system of claim 19, wherein the one or more processors are further configured to execute instructions to:
track processing information; and
store the processing information into a database.

32. The system of claim 31, wherein the processing information comprises at least one of the inquiry requests, the inquiry responses, the completion requests, or the completion responses.

33. The system of claim 32, wherein at least one of the inquiry requests, the inquiry responses, the completion requests, or completion responses are tracked and stored at different intervals.

34. The system of claim 31, wherein the one or more processors are further configured to execute instructions to:
retrieve at least a portion of the processing information from a database; and
display the at least a portion of the processing information on an analyzer terminal.

35. The system of claim 19, wherein each completion requests comprises at least one of a transaction date, a payment date, a name of a payee on a financial instrument, a name of a payer on a financial instrument, a memorandum associated with a financial instrument, an image of a signature associated with a financial instrument, a number associated with a financial instrument, or an image of a financial instrument.

36. The system of claim 35, wherein the one or more processors are further configured to execute instructions to cause a deposit platform to notify the payee.

37. An orchestration layer for electronically processing a real-time payment at a depository bank, the orchestration layer comprising:
a depository bank service comprising:
an inquiry module for building an inquiry request and sending the inquiry request to an intermediary service, the inquiry module comprising a first memory and a first processor;
a completion module for building a completion request and sending the completion request to the intermediary service, the completion module comprising a second memory and a second processor;
a notification module for building a notification request and sending the notification response to the intermediary service, the notification module comprising a third memory and a third processor; and
a reversal module for building a reversal request and sending the reversal response to the intermediary service, the reversal module comprising a fourth memory and a fourth processor.
